(19) United States
(12) Patent Application Publication
(10) Pub. No.: US 2019/0172055 A1
(43) Pub. Date: Jun. 6, 2019

(54) TRANSACTION CARD WITH EMBEDDED PREMIUM CONTENT

(71) Applicant: PAP Investments, Ltd., Dallas, TX (US)

(72) Inventors: Michael J. Hale, Nashville, TN (US); Kevin J. Pease, Mount Juliet, TN (US)

(73) Assignee: PAP Investments, Ltd., Dallas, TX (US)

(21) Appl. No.: 16/180,842

(22) Filed: Nov. 5, 2018

Related U.S. Application Data
(60) Provisional application No. 62/581,383, filed on Nov. 3, 2017.

(51) Int. Cl. G06Q 20/34; G06K 19/077

(52) U.S. Cl. CPC G06Q 20/352; G06K 19/07786; G06Q 20/341

(57) ABSTRACT

A payment card made from rigid plastic, PVC, PET, Styrene, Polypropylene, Tyvek, or other synthetic material, that conforms to ISO 7810 ID-Type 1 form factor, with an embedded passive High Frequency (HF) NFC chip that supports NFC Data Exchange Format (NDEF) encoding. The card has an assigned credit, debit, or prepaid debit account number, is capable of being used for payment of goods or services with the account number imaged on the surface of the card using inkjet, thermal transfer, laser, or other commercially available variable imaging process. The embedded HF NFC chip is linked to the card's payment account number in a remotely hosted database with an association being made to the card's Unique Identification Number (UID), or another unique identifying element encoded into the chip's memory. The embedded HF chip is encoded using NFC Data Exchange Format (NDEF), is encoded to deliver an executable code that directs the cardholder's smartphone, tablet, or other NFC enabled device, to a specific website or app that contains content restricted from general audiences and that is only accessible by said smartphone, tablet, or similar NFC enabled device in the presence of a card designated by the issuer to have access to the site's content only after validating the card has been purchased or received a credit through a qualifying load transaction.

### CROSS-REFERENCE TO RELATED APPLICATIONS

This application claims the benefit of and/or priority to U.S. Provisional Patent Application Ser. No. 62/581,383, filed on 3 Nov. 2017, which is hereby incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to Near Field Communication (NFC) chips and passive NFC chips. More particularly, the present invention relates to a payment card having an embedded passive High Frequency (HF) NFC chip that can support NFC Data Exchange Format (NDEF) encoding. The card can have an assigned account number, e.g., a credit, debit, or prepaid debit account number, and can be used for payment of goods or services and also to access restricted content. The embedded HF NFC chip, which may be separate and distinct from an embedded contactless payment chip, is preferably linked to the card's payment account number in a remotely hosted database with an association being made to a unique identifying element encoded into the chip's memory. The embedded HF NFC chip is encoded using NFC Data Exchange Format to deliver an executable code that directs a cardholder's NFC enabled device to a specific website or software application (“app”) that contains content restricted from general audiences. Such content is accessible by the NFC enabled device in the presence of the card, after validating that a qualifying transaction has occurred.

### 2. General Background of the Invention

A new generation of Near Field Communication (NFC) is emerging that leverages NFC Data Exchange Format (NDEF) encoding of a passive (inductively powered, non-battery powered) NFC chip to provide executable code that directs a powered NFC enabled device such as a smartphone, tablet, etc. to perform functions such as directing the device's internet browser to a specific website or directing the device to a software application (“app”) which can be downloaded to the device. The executable NDEF string is commonly used to direct devices to a specific website where the device holder can interact with the site. The original vision of this technology as developed is for point of purchase marketing as it is intended to facilitate an improved brand experience by allowing product manufacturers to provide data directly to consumers that they cannot provide through the limited space on a bottle label or attached hang tag. This extra information may be in the form of marketing data such as the qualities of a specific vintage of wine, a specific type of organic cotton used in the manufacture of sheets, or to highlight the manufacturer's ecologically sensitive way that they source the materials used in the product. The expanded customer website experience can also direct the registration of a product after purchase and provide post-purchase instructions for safe use and product care.

The other intended use of this technology is to give the consumer the ability to verify the brand authenticity of high-end merchandise, as this allows the consumer to use their device to scan the embedded chip and have the ability to verify the legitimacy of a product through the brand's website prior to purchase.

In general, as described in RFID versus NFC (available at https://blog.atlasrfidstore.com/rfid-vs-nfc and incorporated herein by reference thereto) Radio Frequency Identification (RFID) is a process by which items can be uniquely identified using radio waves. Typically, an RFID system can include a tag, a reader, and an antenna. The reader can send an interrogating signal to the tag via the antenna, and the tag can respond with its unique information. RFID tags can be either active or passive.

Near Field Communication (NFC) is a branch of RFID technology, and a branch of High-Frequency (HF) RFID. Both operate at the 13.56 MHz frequency. NFC provides a secure form of data exchange, and an NFC device can be used as both an NFC reader and an NFC tag, which allows NFC devices to communicate peer-to-peer.

Active RFID tags contain their own power source, e.g., a battery which can enable it to broadcast with a read range of up to about 100 meters. This is considered a long-read range. Passive RFID tags do not have their own power source and can be powered by electromagnetic energy transmitted from an RFID reader. Passive RFID tags can have a read range from near contact and up to about 25 meters.

Passive RFID tags primarily operate at three frequency ranges:

Low Frequency (LF) 125-134 kHz

High Frequency (HF) 13.56 MHz

Ultra High Frequency (UHF) 860 MHz to 960 MHz

Near-field communication devices generally operate at the same frequency (13.56 MHz) as HF RFID readers and tags. Typical standards and protocols of the NFC format are based on RFID standards outlined in ISO/IEC 14443 (International Organization for Standardization/International Electrotechnical Commission (IEC), FeliCa (Felicity Card) technology, and the basis for parts of ISO/IEC 18092. These standards deal with the use of RFID in proximity cards.

Because NFC devices must be in close proximity to each other, usually no more than a few centimeters, NFC technology can provide secure communication between personal consumer devices such as smartphones.

In US2017/0210525 a physical package can contain a token that can be presented as a gift that can be exchanged for an item. The token or the package can include a Radio Frequency Identification (RFID) chip, and a unique identifier can be a unique frequency emitted by the RFID chip.

In US2017/0210525, a token only represents a fixed value article that is used for medium of exchange purposes with redemption limited to the seller of the token or gift card (set dollar amount or a specified good or service).

In US2014/0229377, NFC technology in a phone verifies authenticity of a card being used that is suspected of being compromised. NFC technology is one option of communicating back to the issuer that prompted the cardholder to verify the card. This publication speaks to use in authentication of the card and is looking to validate a physical card that is in the possession of the named card holder and not using a card as a key for access.

In US2008/0082397, a magnetic stripe reader or smart card reader is used at a point of sale, wherein the card is being used as simply a medium of storage and uses retail hardware to update the information stored.

While improving the customer experience is a great use of NFC technology, the present invention is an improvement over the prior art. In the present invention, a payment card or item has passive NFC technology, e.g., an NFC chip or other NFC element, embedded in the payment card or item. An account number of the payment card or item is tied to a Unique Identification Number (UID), or other unique identification element (e.g., a chip serial number), that is encoded in an NFC chip's memory (or memory of another NFC element of the card or item), that can be passed to a remote host in either encrypted or open format. In one or more embodiments ISO standard frequency, e.g., instead of a unique frequency, is used, which allows interaction with common commercially available devices that are designed to connect to NFC enabled items using ISO Standard frequencies. In one or more embodiments, a payment card or item is used as a key to access restricted information and can also be used for a payment transaction. In one or more embodiments, an issuer, marketer and/or consumer goods company, require cardholder initiated interaction with a remote host to perform an action, or complete a task, required by the issuer, for which a credit to the card's or item's prepaid stored value account is applied to compensate the cardholder for their time and voluntary participation in the issuer's program. In one or more embodiments, a payment network is used to verify authenticity or a qualifying event. In one or more embodiments, information encoded into an NFC element does not change and remains fixed. In one or embodiments, a card or item can be used with more than one retailer or merchant.

Incorporated herein by reference are the following patent and patent publication documents:

| | | Issue/Publication |
|---|---|---|
| Pat. No. | Title | Date |
| 8,571,983 | GIFT CARD COMBINATION | Oct. 29, 2013 |
| 8,577,290 | NEAR FIELD COMMUNICATION | Nov. 5, 2013 |
| | ADAPTERS | |
| 8,590,785 | DISCOUNTS IN A MOBILE DEVICE | Nov. 26, 2013 |
| 8,973,819 | GIFT CARD SPLITTING | Mar. 10, 2015 |
| 9,519,895 | GIFT CARD ASSOCIATION WITH | Dec. 13, 2016 |
| | ACCOUNT | |
| 9,639,861 | MESSAGING WITH GREETING | May 2, 2017 |
| | CARD AND GIFT OPTION | |
| 9,679,287 | KIOSK GIFT CARD SYSTEM AND | Jun. 13, 2017 |
| | METHOD | |
| 2008/0082397 | VENDOR SELECTION BASED ON | Apr. 3, 2008 |
| | AUCTION OF CLIENT MARKETING | |
| | CATEGORIES | |
| 2013/0166445 | SYSTEM AND METHOD FOR | Jun. 27, 2013 |
| | PROCESSING GIFT CARDS WHICH | |
| | HIDE SOME GIFT CARD DATA | |
| 2014/0229377 | NFC CARD VERIFICATION | Aug. 14, 2014 |
| 2016/0171525 | SMART REWARDS INCENTIVE | Jun. 16, 2016 |
| | SYSTEM, CLIENT TOOLS FOR | |
| | IMPLEMENTING A SMART | |
| | REWARDS INCENTIVE SYSTEM, | |
| | AND ANALYTICS ENGINE | |
| 2017/0185596 | TRIGGER-BASED CONTENT | Jun. 29, 2017 |
| | PRESENTATION | |
| 2017/0210525 | GIFT ASSEMBLIES | Jul. 27, 2017 |

Incorporated herein by reference are the following webpages and the following documents, which were filed with U.S. Provisional Patent Application Ser. No. 62/581,383, filed on 3 Nov. 2017:
haps://blog.nxp.com/near-field-communication/the-future-of-fan-apparel-nike-the-nba-team-up-with-nfc-to-offer-exclusive-experiences;
RFID For Brand Protection (www.nxp-rfid.com);
NDEF Encoding Overview (www.Gototags.com);
NFC Ideas for Marketers & Advertising Agencies (www.nfc-forum.org/nfc-tool-kit);
NFC: The Future of Fan Apparel (https://blog.nxp.com/near-field-communication/the-future-of-fan-apparel-nike-the-nba-team-up-with-nfc-to-offer-exclusive-experiences).

### BRIEF SUMMARY OF THE INVENTION

A first preferred embodiment of the present invention includes a payment card or item, which can be made from rigid plastic, Polyvinyl Chloride (PVC), polyethylene Terephthalate (PET), styrene, polypropylene, Tyvek® flexible sheets made of polyethylene fibers, or other synthetic material, and which conforms to ISO 7810 ID-Type 1 form factor, with an embedded passive High Frequency (HF) NFC chip that supports NFC Data Exchange Format (NDEF) encoding.

The card can have an assigned account number, e.g., a credit, debit, or prepaid debit account number, and is capable of being used for payment of goods or services. The account number can be imaged on a surface of the card or item using inkjet, thermal transfer, laser, or other commercially available variable imaging processes, or other similar processes or imaging processes to be developed in the future. Preferably, the embedded HF NFC payment chip is linked to the card's or item's account number in a remotely hosted database with an association being made to the card's or item's Unique Identification Number (UID), or another unique identifying element, that is encoded into the chip's or item's memory.

The embedded HF chip is preferably encoded using NFC Data Exchange Format (NDEF) and is encoded to deliver an executable code that directs the cardholder's smart device, e.g., a smartphone, tablet, or other NFC enabled device, to a specific website or app that contains content restricted from general audiences. Such content preferably is only accessible by said smart device, or smartphone, tablet, or similar NFC enabled device, in the presence of a card or item designated by the issuer to have access to the site's content and only after validating that the card has been subject to a qualifying, activating or triggering event, e.g., that the card has been purchased or received a credit through a qualifying retail load transaction.

In other embodiments, restricted content may be accessed when the card is in the presence of the smart device. Generally, as used herein, a smart device refers to an electronic device, that generally can be connected to or share data with other electronic devices or networks via different wireless protocols, such as Bluetooth, NFC, Wi-Fi, 3G, RFID, etc., and which can operate to some extent interactively and autonomously.

In other embodiments, restricted content may be accessed after a card issuer verifies that the card has been subject to a qualifying, activating, or triggering event, e.g., that the card was purchased or that another qualifying transaction or event occurred.

As mentioned, prior art applications have used NFC technology to improve the customer experience. While improving the customer experience is a great use of this technology, the present invention is an improvement over the prior art. In one or more embodiments of the present invention, the NFC chip technology, which preferably is passive NFC chip technology, is embedded in a payment card or item to facility a non-payment transaction but functions to establish a link between the card's payment account and an associated activity. Alternatively, the passive NFC chip can be affixed to or otherwise included as part of a payment card or item. The payment card's or item's account number is tied to the passive NFC chip's or other NFC element's Unique Identification Number (UID) or other unique identification element (e.g., a chip account number) or serial number that is encoded in the chip's memory and can be passed to a remote host in either encrypted or open format.

In one or more embodiments of the present invention, using NFC with NDEF encoding with a payment card or item, e.g., inside a payment card or item, allows the development of several systems that couple the NFC technology with Point-Of-Sale (POS) activation technology to allow verification of a transaction that in essence allows the card or item to serve as a key that must be present to access premium or restricted web content that is only available to cards or items that have qualified action, e.g., transaction. Using NFC with NDEF encoding with a payment card or item, also allows a specific card or item that can be an unregistered or anonymous stored value account, to receive credits for purchases either before or after a purchase transaction.

In preferred embodiments, the passive nature of this NFC chip technology allows any enabled device to read a passive NFC chip of the card or item, e.g., embedded in the card or item, and act on the data. This is an important aspect of the present invention in that any tag, label, card, etc. with this chip technology can be scanned or read by any NFC enabled device and have the executable string read or captured. In a retail marketing deployment of this technology, there is no concern with multiple consumers or potential consumers scanning a label or tag directing consumers to a website that is designed to market the product or provide instructional information. In many instances, a brand marketing manager would value having the scanned data from a tag posted on social media by consumers as it would give the opportunity to expand the reach of the brand and drive traffic to the product website, perhaps by people who would not otherwise consider purchasing or using the product. The open nature of the common technology deployment, however, allows for potential viral spread of the information. An advantage of the present invention is that such potential viral spread of information is greatly lessened, if not eliminated, by the use of a payment network to verify card status and control access to the restricted content, e.g., content on a website, to a specific card or item while in the presence of the card or item, as an objective of the present invention in preferred embodiments is to require physical presence of the card or item.

While NFC with NDEF encoding is not new, the incorporation of the technology in open and closed payment environments is novel and represents new opportunities for merchants, manufacturers, and other potential card or item issuers to connect with consumers in a controlled manner One or more embodiments of the present invention represent a fundamental expansion of applications for stored value cards and stored value accounts using NFC technology in the payment space, which in the prior art has been restricted to contactless payment data where the card, mobile device, or other form factor transmits payment account information as the card's Magnetic Stripe Data (MSD) or contactless EMV data (EMV stands for Europay, MasterCard, Visa global standards for chip-based debit and credit card transaction transactions). Both MSD and EMV formats are designed to communicate strictly with merchant payment terminals and are specifically encrypted to prevent interaction with open websites, apps, or reads by other NFC enabled devices. The current restrictions on NFC technology in payment cards allow the NFC technology to only communicate payment data and prohibit it from being used for expanded applications that are afforded by NDEF encoded technology.

In one or more embodiments of the present invention, the card can remain a magnetic stripe only card and function as a gift or prepaid card for the purposes of facilitating payment transactions; however, it can also have the ability to expand the functionality of the card and reasons for the consumer to keep and use the card on a more regular basis. The NDEF encoded technology would not exclude usage of contactless payment technology with or within the card as payment terminals are generally not designed to accepted NDEF code in the same manner NFC enabled phones or devices are not equipped to process MSD or EMV® contactless payment transactions without an add-on device like a Square merchant terminal. The NFC chip with NDEF encoding can be part of a payment card, e.g., embedded within, a payment card as a stand-alone chip or also potentially can be incorporated into a larger payment chip, with a separate applet on the chip being programmed to provide the NDEF encoding string that is readable by non-payment terminals.

In one or more embodiments of the present invention, ISO standard frequency (ISO stands for International Organization for Standardization standards), instead of unique frequency, for example, is used to transmit data encoded on the chip and/or the chip's UID. This is a novel improvement over prior art applications wherein a physical package can contain a token that can be presented as a gift that can be exchanged for an item, and wherein the token or the package includes an RFID chip, and an identifier that can be a unique frequency emitted by the RFID chip. Using ISO standard frequency is an improvement because it allows interaction with common commercially available devices that are designed to connect to NFC enabled items using ISO Standard frequencies. Articles that use custom frequencies may not properly power up or respond to the ISO standard frequency generated by most common smart phones, tablets, and other standard devices.

In one or more embodiments of the present invention, a stored value account is variable in nature and can represent true currency equivalency through an open payment network where the card's payment functions can be used at either a specific merchant in the case of a closed payment network, or at any merchant of the cardholder's choosing if it is on an open payment network with a major network brand such as Visa, Mastercard, American Express, Discover, JCB, Union Pay, etc. This is also a novel improvement over the prior art, including US2017/0210525, wherein a token generally only represents a fixed value article that is used for medium of exchange purposes with redemption limited to the seller of the token (set dollar amount or a specified good or service).

In one or more embodiments of the present invention, the NFC technology is not used to redeem product but instead serves as a link or bridge between a stored value account and a remote host with the ability to connect a specific card or item with the account and also with possible premium media content that is available on demand to the cardholder, and which is incidental to the payment function and does not directly facilitate the redemption of funds loaded into the card's stored value account. This is also a novel improvement over US2017/0210525, wherein a token is used as a means to redeem a subscription, e.g., to provide access to the recipient for redeeming the subscriptions or to provide a way to give the recipient a physical object (e.g., the token) which can be unwrapped to reveal a later arriving physical gift via the subscription, e.g., a physical magazine would be mailed to the recipient once they redeem the token. The system of US2017/0210525 is very similar to the claim codes used by Apple® with iTunes® and Amazon®.

In one or more embodiments of the present invention, the NDEF encoding of the chip embedded in the card delivers an executable directive that can direct either an app, or the internet browser on the smart device to a specific website such that the user does not have to download an app they do not want in order to interact with the underlying content that the issuer may make accessible through the use of the NFC chip. This presents another novel improvement over US2017/0210525, which discusses a token and an additional gift item that can be a gift card having a component storing an amount of monetary value. The gift card of US2017/0210525 may be separate and distinct from the token and the user has to download an app to a mobile device so that the user can redeem the token.

One or more embodiments of the present invention use the NFC element to provide a link to issuer provided web content that is 1) secondary to the loading of funds onto the stored value account, and 2) provides a link that allows the card's embedded prepaid account to have value added by the issuer or a sponsor that is the result of interaction with the remote hosted multimedia. With the NFC as part of the stored value card, the user does not have to key enter any card data or other information and can remain anonymous to the issuer, unless the load values meet the thresholds where Anti Money Laundering (AML) and Know Your Customer (KYC) regulations direct the issuer to collect cardholder data. This is another novel improvement over the US2017/0210525 which uses the NFC technology in the token for redemption of a subscription.

Additionally, in US2017/0210525 customer redemption of the token using NFC technology is taught as an alternative to bar codes or UFC codes. NFC is indicated as not being accessible at retail to minimize fraud. NFC technology in US2017/0210525, however, is used to pass a static data field that can be easily copied or cloned for redemption by someone with the knowledge of the app and the contents of the box. Unless the material is shielded in the box construction, a good reader can still read the NFC chip that is embedded within a package, so any ability to minimize fraud is minimal given the use of only a physical barrier of the package. One or more embodiments of the present invention are a novel improvement, in that encryption in the data string can be used along with the verification of a purchase transaction before allowing redemption. In one or more embodiments of the present invention, redemption can be based on a remote host's verification of a purchase transaction before allowing the redemption of a claim code or token redemption by a card, based on the NFC technology embedded in the card.

In one or more embodiments of the present invention, the functionality of the card uses the NFC element to facilitate access to remote hosted content and/or to provide a linkage between a prepaid account and a link to allow loading of funds to an associated prepaid account. This is a novel improvement over US Publication No. US2008/0082397, for example, in which a remote database can be used for tracking, but the card is updated with a magnetic stripe reader or smart card reader at a point of sale, wherein the card is being used as simply a medium of storage and uses retail hardware to update the information stored on the chip.

In one or more embodiments of the present invention, data on the NFC chip is not changed as the data encoded on the chip is not intended to be updated with post issuance interaction with terminals. The NDEF encoding is designed to direct a mobile device to a specific web portal and to use encrypted credentials in the card and a remote hosted database to verify a purchase transaction and/or a qualifying activating event or trigger, such as multimedia interaction in order for financial credits to be applied to the stored value account associated with the card's embedded NFC element.

In one or more embodiments of the present invention, the marketing element utilized with a transaction card has the issuer, marketer and/or consumer goods company, require a cardholder-initiated interaction with the remote host to perform an action or complete a task required by the issuer, for which a credit to the card's prepaid stored value account is applied to compensate the cardholder for their time and voluntary participation in the issuer's program. This is a novel improvement over the passive system of US2008/0082397, which references a voucher system for advertisements with the voucher possibly being a card distributed to a user. The publication discusses web-based target marketing based on the websites a user visits. A chip is referenced as an alternative to a magnetic stripe and is described as being used to deliver advertisements corresponding to advertisements in a consumer's gift basket. The chip in US2008/0082397 is a medium of storage for an advertisement, and like the booklet and e-mail also referenced, just serves as a way to deliver a voucher that is linked to an offer that the marketer expects the recipient may use, based on their web search history. The voucher is generated by bidding of advertiser of products that may be of interest to a recipient based on what they search for on the internet. This is passive as the voucher spoken about is based on surveillance of recipient activities and does not require the recipient to perform an issuer directed activity to receive a credit or voucher. Whereas, the marketing element of one or more embodiments of the present invention has the issuer, marketer and/or consumer goods company, require cardholder initiated interaction with the remote host to perform an action, or complete a task, required by the issuer, for which a credit to the card's or item's prepaid stored value account is applied to compensate the cardholder for their time and voluntary participation in the issuer's program.

In one or more embodiments of the present invention, a payment network is used to verify purchase activity on the associated card's debit account to access media and to credit funds to the card's associated prepaid account. This is a novel improvement over, US Publication No. 2014/0229377, which uses NFC technology in a phone to verify authenticity of a card being used that is suspected of being compromised. NFC technology is one option of communicating back to the issuer that prompted the cardholder to verify the card. This publication speaks to use in authentication of the card and is looking to validate a physical card is in the possession of the named card holder and not using a card as a key for access, for example.

In one or more embodiments of the present invention, a payment card or item is made from rigid plastic, PVC, PET, styrene, polypropylene, Tyvek®, or other synthetic material, conforming to ISO 7810 ID-Type 1 form factor, with an embedded passive High Frequency (HF) NFC chip that supports NFC Data Exchange Format (NDEF) encoding. The card or item has an assigned identifier, e.g., an account number, e.g., a credit, debit, or prepaid debit account number, and is capable of being used for payment of goods or services with the account number, which can be imaged on a surface of the card or item using inkjet, thermal transfer, laser, or other commercially available variable imaging processes.

The embedded HF NFC payment chip is preferably linked to the card's or item's identifier or account number in a remotely hosted database with an association being made to the card's or item's Unique Identification Number (UID), or another unique identifying element encoded into the chip's memory. The UID can be the same as the card or item identifier or account number or a different unique identifying element in the chip's memory. The embedded HF NFC chip, encoded using NFC Data Exchange Format (NDEF), is encoded to deliver an executable code that directs the cardholder's smart device, e.g., a smartphone, tablet, or other NFC enabled device to a specific website or app that contains content restricted from general audiences and is only accessible by said smart device, smartphone, tablet, or similar NFC enabled device in the presence of the card or item designated by the issuer to have access to the site's content, and preferably only after validating the card or item has been purchased or received a credit through a qualifying retail load transaction.

In one or more embodiments of the present invention, a payment card is made from rigid plastic, PVC, PET, styrene, polypropylene, Tyvek®, or other synthetic material, conforming to ISO 7810 ID-Type 1 form factor (or to other similar standards or systems currently available or to be developed in the future), with a passive High Frequency (HF) NFC chip, which can be embedded in the card, and which supports NFC Data Exchange Format (NDEF) encoding. The card has an assigned identifier, e.g., an account number, e.g., a credit, debit, or prepaid debit account number, and is capable of being used for payment of goods or services with the card identifier or account number, which can be imaged on the surface of the card using inkjet, thermal transfer, laser, or other commercially available variable imaging process, or other process to be developed in the future. The embedded HF NFC payment chip is linked to the card's identifier or payment account number in a remotely hosted database with an association being made to a Unique Identification Number (UID), or other unique identifying element of the card that is encoded into the chip's memory; the embedded HF NFC chip, encoded using NFC Data Exchange Format (NDEF), is encoded to deliver an executable code that directs the cardholder's smart device, smartphone, tablet, or other NFC enabled device, to a specific website or app that contains content restricted from general audiences and which preferably is only accessible by said smart device, smartphone, tablet, or similar NFC enabled device in the presence of the card designated by the issuer to have access to the site's content, and preferably only after validating the card has been purchased or received a credit through a qualifying retail load transaction.

In various embodiments, the website verifies that the payment card identifier or account number transmitted in the NDEF data stream corresponds with the UID of the chip embedded in the card.

In various embodiments, the verification of purchase by the website also includes an account balance inquiry that can be used to restrict access to content on the basis of the account balance, account activity, specific products purchased with said card, or other account specific criteria established by the card issuer.

In various embodiments, the verification of purchase by the website also includes an account balance inquiry that can be used to restrict access to content on the basis of the account balance, account activity, specific products purchased with said card, or other account specific criteria established by the card issuer that are in accordance with the terms and conditions of the account as issued or published by the issuer at the time the card is sold or conveyed to the initial recipient of the card.

In various embodiments, the website captures the card's identifier or account number, UID, or other uniquely identifiable element, and uses at least one of the identifying elements to convey to the card issuer that the cardholder has watched a video, completed a survey, selected crediting the card as an exchange for another award from a loyalty program, or performed a task requested by the issuer as a condition for crediting the card's account with funds, purchase credits, purchase units, or other form of stored value that can be used for subsequent purchase of goods and services.

In one or more embodiments of the present invention, an item can be a card, letter, greeting card, or other format not conforming to the standard form factor requirements designated by ISO 7810 ID-Type 1. The item can be made of paper, PVC, PET, styrene, polypropylene, Tyvek®, or other suitable material that is about 3 mils to 60 mils thick (75 to 1520 microns) with an embedded or affixed passive High Frequency (HF) RFID chip that supports NFC Data Exchange Format (NDEF) encoding. The item, having an assigned identifier or account number, e.g., a credit, debit, or prepaid debit account number, is capable of being used for payment of goods or services with the item identifier or account number which can be imaged on a surface of the item, e.g., using inkjet, thermal transfer, laser, or other commercially available variable imaging process or other process to be developed in the future. The embedded HF NFC payment chip is linked to the item's identifier or account number in a remotely hosted database with an association being made to the item's Unique Identification Number (UID), or another unique identifying element that is encoded into the chip's memory. The HF chip, encoded using NFC Data Exchange Format (NDEF), is encoded to direct a smartphone, tablet, or other NFC enabled device, to a specific website or app that contains content restricted from general audiences and is preferably only accessible by said smartphone, tablet, or similar NFC enabled device in the presence of an item designated by the issuer to have access to the site's content, and preferably only after validating that a qualifying event or action has occurred for the item, e.g., that the item has been purchased through a qualifying retail transaction.

In various embodiments, the website or app verifies that the item identifier or account number transmitted in the NDEF data stream corresponds with the UID of the chip embedded in said item.

In various embodiments, a card or item identifier can be the same as, or different from, a UID of the chip or element of the card or item.

In various embodiments, the verification of purchase by the website also includes an account balance inquiry that can be used to restrict access to content on the basis of account balance, account activity, specific products purchased with said item, or other account specific criteria established by the issuer.

In various embodiments, the verification of purchase by the website also includes an account balance inquiry that can be used to restrict access to content on the basis of account balance, account activity, specific products purchased with said item, or other account specific criteria established by the issuer that are in accordance with the terms and conditions of the account as published by the issuer at the time the item is sold or conveyed to the initial recipient of the item.

In various embodiments, the website captures the item's identifier or account number, UID, or other uniquely identifiable element, and uses at least one of the identifying elements to convey to the issuer that the item holder has watched a video, completed a survey, selected crediting the card as an exchange for another award from a loyalty program, or performed a task requested by the issuer as a condition for crediting the item's associated payment account with funds, purchase credits, purchase units, or other form of stored value.

One or more embodiments of the present invention include an item, card, tag, label, letter, greeting card, or other format that may or may not conform to standards designated by ISO 7810 ID-Type 1, made of paper, PVC, PET, styrene, polypropylene, Tyvek®, or other material that is about 3 mils to 60 mils thick (75 to 1520 microns) with an embedded or affixed passive High Frequency (HF) RFID chip or element that supports NFC Data Exchange Format (NDEF) encoding. The item preferably is assigned an identifier or account number, e.g., a stored value account number, payment account number, prepaid debit account number, or loyalty program account number, that allows the item or item's associated identifier or account number to be used for payment for goods or services. The identifier or account number may or may not be imaged on the surface of the item in human readable and/or machine readable form using inkjet, thermal transfer, laser, or other commercially available means of printing variable data, or other process to be developed in the future. The HF NFC chip also preferably has a Unique Identification Number (UID) or other unique identifying element encoded into the chip's memory that is linked in a database to the item's identifier or account number. The embedded HF chip, preferably encoded using NFC Data Exchange Format (NDEF), is encoded to direct a smart device, smartphone, tablet, or other NFC enabled device, to a specific website or app that is only accessible by said smartphone, tablet, or similar NFC enabled device in the presence of the item designated by the issuer to have access to the site. Upon accessing the restricted site using the embedded NFC chip with NDEF encoded string, the holder of the smart device can associate a qualifying purchase with the account to receive a form of stored value, e.g., an instant rebate or purchase credit to be applied to the stored value account associated with said item, e.g., in accordance with terms of the issuer's program guidelines.

In various embodiments, scanning of a product's embedded NFC tag, RFID tag, label, or loyalty reward card is used to identify the item qualifying for the rebate or purchase credit.

In various embodiments, the website or app prompts the smart device to use a camera to scan a bar code or OCR (Optical Character Recognition) readable claim code in order to receive an instant rebate in the form of a credit to the item's associated stored value account, preferably in accordance with the terms of the issuer's program guidelines.

In various embodiments, the website or app requires a scan or photo of a purchase receipt to be submitted and verified by the issuer prior to any stored value, reward or incentive credits being applied to the stored value card.

In various embodiments, the website or app requires the cardholder to enter purchase specific data manually.

In various embodiments, the stored value, credit or funds applied to the stored value account are made prior to the purchase of an item and based on a device's scan of an embedded NFC tag, QR (Quick Response) bar code, claim code, or another unique element used by the product manufacturer, distributor, or retailer to identify the product.

In various embodiments, the stored valued, funds or loyalty credits applied prior to purchase may have an extremely limited expiration period of only a few seconds to a few minutes.

In various embodiments, the stored valued, funds or loyalty credits applied prior to purchase may have an extremely limited expiration period of only a few seconds to a few minutes and can be restricted for redemption of purchase only of said item or items scanned and associated with the stored value account.

In various embodiments, the web browser or app in the smart device uses the GPS coordinates of the cardholder's smart device and uses the coordinates to validate the purchase from an authorized retail location prior to applying stored value, e.g., award credits, to the item's associated stored value identifier or account number.

In various embodiments, the stored value, e.g., credit or funds, applied to the stored value account are made only after the item has been purchased and the purchaser performs an action directed by the issuer that prohibits the product from being returned to the merchant for refund.

In various embodiments, the stored value, e.g., credit or funds, applied to the stored value account expire once the GPS (Global Positioning System) location of the consumer's device is outside of the retail location where the purchase incentive is offered.

In various embodiments, the NFC chip or NFC element has a frequency of about 13.56 mHz and is designed to be read when in close proximity, e.g., less than 10 cm to an NFC enabled device.

In various embodiments, the NFC chip or NFC element has a frequency of about 12.2 to 14.9 mHz.

In various embodiments, an UHF NFC chip or element has a frequency of about be 860 to 960 MHz.

In various embodiments, the NFC chip or NFC element is designed to be read when about 4 cm or closer to an NFC enabled device; though, longer read distances are not excluded.

In preferred embodiments, the NFC chip or NFC element has a frequency of about 13.56 mHz and is designed to be read when the chip or element is at a distance of about 1 to 4 cm away from an NFC enabled device; though, longer read distances are not excluded.

In general, a UHF frequency band can cover a range from 300 MHz to 3 GHz. The full UHF spectrum is 300 MHz to 3000 MHz, and systems complying with UHF Gen (Generation) 2 standard for RFID currently use an 860 to 960 MHz band. As systems begin using other generation standards, specific frequencies can be selected based on the system's frequency capability. As other areas of the spectrum become available, future embodiments of the system, method and apparatus of the present invention can potentially use any such other areas of the spectrum as may desired.

In various embodiments, a consumer can use an NFC enabled device to scan or read an embedded chip in an item or payment card and have the ability to verify the legitimacy of a product through the brand's website prior to purchase.

In various embodiments, a consumer can use an NFC enabled device to scan or read an NFC element of an item or payment card and have the ability to verify the legitimacy of a product through a brand's website prior to purchase.

In various embodiments, purchase of an item or tag can be an activating event.

In various embodiments a card or item can be purchased online.

In various embodiments a card or item can be purchased online and received at a later date.

In various embodiments a card or item can be purchased at a traditional retail outlet, e.g., a brick and mortar store.

In some embodiments that involve purchase of a good, scanning of a tag on the good is an activating event.

In some embodiments, if a good is purchased on-line, scanning of a tag on the good at a later date, e.g., after delivered to a purchaser address, can be an activating event.

In some embodiments, scanning of an item, which can be coupled to a good is an activating event.

In some embodiments, scanning of an item, which can accompany a good is an activating event.

The prior art systems and methods do not allow for, or provide, real time authentication by a brand merchant of a purchase, or completion of a task, that will trigger a reward or grant of an incentive to a purchaser. The prior art systems and methods also do not allow for, or provide, real time communication between a brand merchant and a purchaser prior to the purchaser exiting a retail store. The prior art systems and methods also do not allow for, or provide, real time or at least nearly instantaneous rewarding of a purchaser based on actions completed by the purchaser. In one or more embodiments of the present invention, the apparatus, system and/or method of the present invention solves a technological problem in the prior art by enabling purchasers of a product to communicate in real time with an issuer of a product, prior to exiting a shopping area, for example. In one or more other embodiments, the apparatus, system and method of the present invention also solve a technological problem in the prior art by enabling real time authentication of purchase by a brand merchant, or authentication of another completed task, that triggers a reward or grant of an incentive to the purchaser. In one or more other embodiments, the apparatus, system and method of the present invention also solve a technological problem by providing real time, or at least nearly instantaneous, rewards or rebates or other incentives to a purchaser, at least almost instantaneously after completion of a task. In one or more other embodiments, the apparatus, system and method of the present invention also solve a technological problem by providing an item or a card that is a “key” to unlock restricted information or a reward for a card holder or an item holder.

In one or more embodiments, a system for providing access to restricted content comprises:

a) a transaction card having:
i) a card identifier, and
ii) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;

b) a remote host at which the card identifier and chip identifier are linked;

c) wherein the transaction card has an activation function, and wherein when the card is used in an activating event the activating event for the card is recorded at the remote host; and

d) wherein the transaction card has a restricted content access function wherein the restricted content is accessible after the activating event and when the card is in the presence of the NFC enabled device and delivers the executable code to the NFC enabled device that directs the NFC enabled device to the restricted content.

In one or more embodiments of the system of the present invention, the NFC enabled device is directed to the restricted content which is on a designated website or software application (“app”) and wherein the restricted content is still restricted after step “d” until a qualifying event is performed at the website or app.

In one or more embodiments of the system of the present invention, the qualifying event includes reading content, watching content, or completing a survey.

In one or more embodiments of the system of the present invention, the transaction card is a payment card.

In one or more embodiments of the system of the present invention, the activating event is purchase of the payment card.

In one or more embodiments of the system of the present invention, the payment card includes magnetic stripe data (MSD) or EMV payment chip data.

In one or more embodiments of the system of the present invention, the chip identifier and card identifier are passed to the remote host in encrypted or format.

In one or more embodiments of the system of the present invention, the chip identifier and card identifier are passed to the remote host in open format.

In one or more embodiments of the system of the present invention, the executable code includes an encoded link that serves as a verification element that verifies purchase of the payment card and activates the restricted content on the website or app.

In one or more embodiments of the system of the present invention, the remote host is secure.

In one or more embodiments of the system of the present invention, the NFC enabled device reads the NFC chip and is directed to a website, and upon landing at the website the card identifier is checked to verify purchase before allowing access to the restricted content.

In one or more embodiments of the system of the present invention, after the purchase is verified, the restricted content on the website is released for viewing by the NFC enabled device.

In one or more embodiments of the system of the present invention, the NFC enabled device is a smartphone or tablet, and the NFC enabled device reads the NFC chip which directs the NFC enabled device to an internet browser and to a specific website.

In one or more embodiments of the system of the present invention, the NFC chip can be passive High Frequency (HF) chip.

In one or more embodiments of the system of the present invention, the transaction card includes an Ultra High Frequency (UHF) chip.

In one or more embodiments of the system of the present invention, transaction card contains an HF antenna.

In one or more embodiments of the system of the present invention, the transaction card contains a UHF antenna.

In one or more embodiments of the system of the present invention, the transaction card contains both an HF chip and UHF chip and an HF antenna and UHF antenna.

In one or more embodiments of the system of the present invention, the NFC chip is a combination HF frequency and UHF frequency chip and the transaction card contains a combination HF and UHF antenna.

In one or more embodiments a payment card with embedded restricted content comprises:

a) a card identifier;

b) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;

c) wherein the card identifier and chip identifier are linked in a remote host;

d) the payment card having a payment function, the payment card operable to complete the payment function with either magnetic stripe data or contactless EMV formats;

e) the payment card having an activation function wherein when the card is used in an activating event the activating event for the card is recorded at the remote host; and

f) wherein the payment card has a restricted content access function wherein the restricted content is accessible after the activating event and when the payment card is in the presence of the NFC enabled device and delivers the executable code to the NFC enabled device that directs the NFC enabled device to the restricted content.

In one or more embodiments of a payment card with embedded restricted content, the activating event is purchase of the payment card.

In one or more embodiments of a payment card with embedded restricted content, the chip identifier and card identifier are passed to the remote host in either encrypted or open format.

In one or more embodiments of a payment card with embedded restricted content, the card is made from rigid plastic, PVC, PET, styrene, polypropylene, Tyvek®, or other synthetic material, paper, or metal.

In one or more embodiments of a payment card with embedded restricted content, the card conforms to ISO 7810 ID-Type 1 form factor.

In one or more embodiments of a payment card with embedded restricted content, the NFC chip is a passive High Frequency (HF) NFC chip.

In one or more embodiments of a payment card with embedded restricted content, the payment card contains an HF antenna.

In one or more embodiments of a payment card with embedded restricted content, the card includes an Ultra High Frequency (UHF) chip.

In one or more embodiments of a payment card with embedded restricted content, the payment card contains a UHF antenna.

In one or more embodiments of a payment card with embedded restricted content, the NFC chip is a combination HF frequency and UHF frequency chip and the transaction card contains a combination HF and UHF antenna.

In one or more embodiments of a payment card with embedded restricted content, the NFC chip is a combination HF frequency and UHF frequency chip and the transaction card contains an HF antenna and a UHF antenna.

In one or more embodiments of a payment card with embedded restricted content, the payment card is a credit card, a debit card, a gift card, or a pre-paid debit card.

In one or more embodiments of a payment card with embedded restricted content, the card identifier is an account number that is imaged on a surface of the payment card using inkjet, thermal transfer, laser, or other commercially available variable imaging process.

In one or more embodiments of a payment card with embedded restricted content, the payment function of the payment card can be carried out using the card identifier.

In one or more embodiments of a payment card with embedded restricted content, the restricted content is restricted to general audiences and only accessible based on the activation function and the restricted content access function of the payment card.

In one or more embodiments of a payment card with embedded restricted content, the NFC enabled device is directed to a web page or software application (“app”) on the device to access the restricted content.

In one or more embodiments of a method for providing access to restricted media or marketing content, the method includes the following steps:

a) providing a transaction card having:
i) a card identifier, and
ii) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;

b) linking the card identifier and chip identifier at a remote host;

c) activating the transaction card via an activating event and recording the activating event at the remote host; and

d) positioning the card and the NFC enabled device together so that the NFC chip delivers the executable code to the NFC enabled device and directs the NFC enabled device to a designated website or software application (“app”) including the restricted content.

In one or more embodiments of a method for providing access to restricted media or marketing content, the NFC enabled device is directed to a designated website or software application (“app”) including the restricted content and restricted content is accessible after accessing the designated website or app.

In one or more embodiments of a method for providing access to restricted media or marketing content, the restricted content is still restricted after step “d” until a qualifying event is performed at the website or app.

In one or more embodiments of a method for providing access to restricted media or marketing content, the qualifying event includes reading content, watching content, or completing a survey.

In one or more embodiments of a method for providing access to restricted media or marketing content, the transaction card that is provided is a payment card.

In one or more embodiments of a method for providing access to restricted media or marketing content, the activating event is purchase of the payment card.

In one or more embodiments of a method for providing access to restricted media or marketing content, the payment card includes magnetic stripe data (MSD) or EMV payment data.

In one or more embodiments of a method for providing access to restricted media or marketing content, the chip identifier and card identifier is passed to the remote host in either encrypted or open format.

In one or more embodiments of a method for providing access to restricted media or marketing content, the restricted content is accessible after the website verifies the transaction card has been purchased or received a credit through a qualifying retail load transaction.

In one or more embodiments of a method for providing access to restricted media or marketing content, the website verifies that the card identifier transmitted in an NDEF data stream corresponds with the chip identifier of the transaction card.

In one or more embodiments of a method for providing access to restricted media or marketing content, the payment card has an account associated with the payment card, and the website verifies purchase of the payment card, wherein the verification of purchase by the website includes an account balance inquiry that is used to restrict access to the restricted content on the basis of certain account characteristics, including account balance, account activity, specific products purchased with the transaction card, or other account specific criteria established by a card issuer that are in accordance with terms and conditions of the account as published by the card issuer at the time the transaction card is sold or conveyed to an initial recipient of the payment card.

In one or more embodiments of a method for providing access to restricted media or marketing content, the website captures the card identifier and uses one or more identifying elements to convey to a card issuer that a cardholder has watched a video, completed a survey, selected crediting the card as an exchange for another award from a loyalty program, or performed a task requested by the card issuer as a condition for crediting the transaction card with stored value, including funds, purchase credits, purchase units, or other form of stored value that can be used for subsequent purchase of goods and services.

In one or more embodiments of a method for providing access to restricted media or marketing content, after completing the activating event, a card issuer credits the transaction card with stored value.

In one or more embodiments, a system for providing access to restricted content comprises:

a) an item that has:
i) an item identifier; and
ii) a near field communication (NFC) element with an element identifier, the NFC element encoded with an executable code, and wherein the NFC element supports NFC Data Exchange Format (NDEF) encoding and is operable to deliver the executable code to an NFC enabled device;

b) a remote host at which the item identifier and element identifier are linked;

c) the item having an activation function, and wherein when the item is subject to an activating event the activating event for the item is recorded at the remote host; and

d) the item having a restricted content access function wherein the restricted content is accessible after the activating event and when the item is in the presence of the NFC enabled device and delivers the executable code to the NFC enabled device that directs the NFC enabled device to the restricted content.

In one or more embodiments of a system for providing access to restricted content, the NFC enabled device is directed to a web page or software application (“app”) to access the restricted content.

In one or more embodiments of a system for providing access to restricted content, the NFC element is coupled to the item.

In one or more embodiments of a system for providing access to restricted content, the NFC element is embedded in the item.

In one or more embodiments of a system for providing access to restricted content, the item is a transaction card, key fob, hang tag with a transaction card, label, letter, or greeting card.

In one or more embodiments of a system for providing access to restricted content, the item does not conform to standard form factor requirements designated by ISO 7810 ID-Type 1.

In one or more embodiments of a system for providing access to restricted content, the item does conform to standard form factor requirements designated by ISO 7810 ID-Type 1.

In one or more embodiments of a system for providing access to restricted content, the NFC element is a passive High Frequency (HF) RFID chip.

In one or more embodiments of a system for providing access to restricted content, the item contains an HF antenna.

In one or more embodiments of a system for providing access to restricted content, the item contains an Ultra High Frequency (UHF) chip.

In one or more embodiments of a system for providing access to restricted content, the item contains a UHF antenna.

In one or more embodiments of a system for providing access to restricted content, the item contains an HF/UHF combination chip as the NFC element.

In one or more embodiments of a system for providing access to restricted content, the item contains both an HF antenna and a UHF antenna or wherein the item contains a combination HF/UHF antenna.

In one or more embodiments of a system for providing access to restricted content, as part of the restricted content access function the item is a key, wherein the restricted content is only accessible by the NFC enabled device in the presence of the item.

In one or more embodiments of a system for providing access to restricted content, the restricted content is accessible by an item holder after the NFC enabled device is directed to a web page or app at which an item issuer validates that a qualifying event has occurred.

In one or more embodiments of a system for providing access to restricted content, the qualifying event is purchase of the item.

In one or more embodiments of a system for providing access to restricted content, the item is made of paper, PVC, PET, styrene, polypropylene, Tyvek®, metal or other material.

In one or more embodiments of a system for providing access to restricted content, the item is 3 mils to 60 mils thick (75 to 1520 microns).

In one or more embodiments of a system for providing access to restricted content, the web page or app verifies the item identifier which is transmitted in an NDEF data stream and correlates with the element identifier.

In one or more embodiments of a system for providing access to restricted content, there is an item account and wherein the verification of the item identifier includes an account balance inquiry that can be used to restrict access to content on the basis of an account balance, account activity, specific products purchased with said item, or other account specific criteria established by an item issuer that are in accordance with terms and conditions of the item account as issued by the issuer at the time the item is obtained by item holder.

In one or more embodiments of a system for providing access to restricted content, a web page or app captures the item identifier and uses the item identifier as an identifying element to convey to an item issuer that an item holder has watched a video, completed a survey, selected crediting the card as an exchange for another award from a loyalty program, or performed a task requested by the item issuer as a condition for crediting an item account of the item with an associated payment of funds, purchase credits, purchase units, or other form of stored value.

In one or more embodiments, a method for providing access to restricted content includes the following steps:

a) providing an item that has:
i) an item identifier; and
ii) a near field communication (NFC) element with an element identifier, the NFC element encoded with an executable code, and wherein the NFC element supports NFC Data Exchange Format (NDEF) encoding and is operable to deliver the executable code to an NFC enabled device; and
iii) wherein the item identifier and element identifier are linked at a remote host;

b) performing an activating event to activate the item; and

c) accessing restricted content after the activating event and when the item is in the presence of the NFC enabled device and delivers the executable code to the NFC enabled device that directs the NFC enabled device to the restricted content.

In one or more embodiments, a method for providing access to restricted content includes the following steps:

a) providing an item that has:
i) an item identifier; and
ii) a near field communication (NFC) chip with a chip identifier, the NFC chip encoded with an executable code, and wherein the NFC chip supports NFC Data Exchange Format (NDEF) encoding and is operable to deliver the executable code to an NFC enabled device; and
iii) wherein the item identifier and chip identifier are linked at a remote host;

b) putting the item and NFC enabled device in a desired proximity so that NFC enabled device delivers the executable code to the NFC enabled device and directs the NFC enabled device to an activating event;

c) performing an activating event to activate the item; and

d) accessing restricted content after the activating event.

In one or more embodiments, an item for providing access to restricted content comprises:
a) an item identifier;
b) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;
c) wherein the item identifier and chip identifier are linked in a remote host;
d) the item having a payment function;
e) the item having an activation function wherein when the item is subject to an activating event and the activating event for the item is recorded at the remote host; and
f) wherein the item has a restricted content access function wherein the restricted content is accessible when the item is in the presence of the NFC enabled device and delivers the executable code to the NFC enabled device that directs the NFC enabled device to a designated website or software application (“app”) including the restricted content.

In one or more embodiments, an item for providing access to restricted content comprises:
a) an item identifier;
b) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;
c) wherein the item identifier and chip identifier are linked in a remote host; and
d) wherein the item has a restricted content access function wherein the restricted content is accessible when the item is in the presence of the NFC enabled device and delivers the executable code to the NFC enabled device that directs the NFC enabled device to the restricted content.

In one or more embodiments, a system for providing stored value to an item account based on one or more qualifying actions comprises:

a) an item that includes:
i) an item identifier, that an item issuer uses to identify the item;
ii) an embedded or affixed passive High Frequency (HF) RFID chip that supports NFC Data Exchange Format (NDEF) encoding;

b) an item account associated with the item identifier;

c) a remote host at which the item identifier and the chip are associated with one another;

d) the item having a restricted access function wherein restricted content is accessible when the chip is read by a device; and

e) a qualifying action requirement, wherein if the qualifying action requirement is satisfied, the stored value is applied to the item account.

In one or more embodiments of a system for providing stored value to an item account based on one or more qualifying actions, the item identifier is a machine readable element and the restricted content is accessible when the machine readable element is read by a device, website or software application (“app”).

In one or more embodiments of a system for providing stored value to an item account based on one or more qualifying actions, the machine readable element is selected from the following group:
(a) a near field communication (NFC) element, the NFC element encoded with an executable code, and wherein the NFC chip supports NFC Data Exchange Format (NDEF) encoding and is operable to deliver the executable code to an NFC enabled device;
(b) a QR bar code;
(c) a claim code;
(d) an RFID; or
(e) another desired unique element used by an item manufacturer, distributor, or retailer to identify the item.

In one or more embodiments of a system for providing stored value to an item account based on one or more qualifying actions, the item is a card, tag, label, letter, greeting card, or other desired format that may or may not conform to standards designated by ISO 7810 ID-Type 1.

In one or more embodiments of a system for providing stored value to an item account based on one or more qualifying actions, the item is made of paper, PVC, PET, styrene, polypropylene, Tyvek, metal or other desired material.

In one or more embodiments of a system for providing stored value to an item account based on one or more qualifying actions, the item is 3 mil to 60 mil thick (75 to 1520 microns).

In one or more embodiments of a system for providing stored value to an item account based on one or more qualifying actions, the machine readable element is an NFC chip and wherein the NFC chip is embedded in the item or affixed to the item.

In one or more embodiments of a system for providing stored value to an item account based on one or more qualifying actions, the machine readable element is an NFC chip and wherein the NFC chip is a passive High Frequency (HF) RFID chip.

In one or more embodiments of a system for providing stored value to an item account based on one or more qualifying actions, the machine readable element is an Ultra High Frequency (UHF) chip.

In one or more embodiments of a system for providing stored value to an item account based on one or more qualifying actions, the item contains an HF antenna.

In one or more embodiments of a system for providing stored value to an item account based on one or more qualifying actions, the item contains a UHF antenna.

In one or more embodiments of a system for providing stored value to an item account based on one or more qualifying actions, the item contains more than one machine readable elements.

In one or more embodiments of a system for providing stored value to an item account based on one or more qualifying actions, the more than one machine readable elements are chips.

In one or more embodiments of a system for providing stored value to an item account based on one or more qualifying actions, one chip is a passive High Frequency (HF) chip and another chip is an Ultra High Frequency (UHF) chip.

In one or more embodiments of a system for providing stored value to an item account based on one or more qualifying actions, the item contains an HF antenna and an UHF antenna.

In one or more embodiments of a system for providing stored value to an item account based on one or more qualifying actions, the item is usable for payment of goods or services.

In one or more embodiments of a system for providing stored value to an item account based on one or more qualifying actions, the item account is a loyalty account and wherein the stored value is reward points.

In one or more embodiments of a system for providing stored value to an item account based on one or more qualifying actions, the stored value is a rebate or an instant rebate.

In one or more embodiments of a system for providing stored value to an item account based on one or more qualifying actions, the stored value is a purchase credit.

In one or more embodiments of a system for providing stored value to an item account based on one or more qualifying actions, the stored value is a monetary value.

In one or more embodiments of a system for providing stored value to an item account based on one or more qualifying actions, a scan of the item's embedded NFC chip is used to identify the item qualifying for a rebate or purchase credit or loyalty incentive.

In one or more embodiments of a system for providing stored value to an item account based on one or more qualifying actions, the website or app prompts the NFC enabled device to use a camera to scan the machine readable element of the item in order to receive an instant rebate in the form of a credit to the item account in accordance with terms of an item issuer's program guidelines.

In one or more embodiments of a system for providing stored value to an item account based on one or more qualifying actions, the website or app requires a scan or photo of a purchase receipt to be submitted and verified by the item issuer prior to issuing the stored value, which is a reward or incentive credits.

In one or more embodiments of a system for providing stored value to an item account based on one or more qualifying actions, the website or app requires an item holder of the item to enter purchase specific data manually.

In one or more embodiments of a system for providing stored value to an item account based on one or more qualifying actions, the stored value is a credit of funds or loyalty credits that are applied to the item account prior to a purchase of a good and wherein the credit of funds occurs after a device's scan of a bar code on the good.

In one or more embodiments of a system for providing stored value to an item account based on one or more qualifying actions, the funds or loyalty credits have a limited expiration period of a few seconds to a few minutes and are restricted for redemption of purchase only of the good scanned and associated with the item account.

In one or more embodiments of a system for providing stored value to an item account based on one or more qualifying actions, the device has a web browser or a device app that uses GPS coordinates of the device to validate a purchase from an authorized retail location prior to applying the stored value to the item account.

In one or more embodiments of a system for providing stored value to an item account based on one or more qualifying actions, the stored value is a credit or funds that are applied to the stored value account only after the item has been purchased from a merchant and the purchaser performs an action directed by the issuer that prohibits the item from being returned to the merchant for refund.

In one or more embodiments of a system for providing stored value to an item account based on one or more qualifying actions, the stored value is a credit or funds that are applied to the stored value account and expire once the GPS location of the consumer's device is outside of a retail location where the stored value is offered.

In one or more embodiments, a stored value item comprises:

a) an item identifier;

b) a near field communication (NFC) element, the NFC element encoded with an executable code, and wherein the NFC element supports NFC Data Exchange Format (NDEF) encoding and is operable to deliver the executable code to an NFC enabled device;

c) an item account associated with the item identifier;

d) a restricted access function wherein restricted access to a website or software application (“app”) is accessible when the item identifier is read by a device; and

e) a qualifying action requirement, wherein if the qualifying action requirement is satisfied, a stored value is applied to the item account.

In one or more embodiments of a stored value item, the item identifier is a machine readable element that is selected from the following group:
(a) a near field communication (NFC) element, the NFC element encoded with an executable code, and wherein the NFC element supports NFC Data Exchange Format (NDEF) encoding and is operable to deliver the executable code to an NFC enabled device;
(b) a QR bar code;
(c) a claim code;
(d) an RFID; or
(e) another desired machine readable element used by an item manufacturer, distributor, or retailer to identify the item.

In one or more embodiments of a stored value item, the item is a card, tag, label, letter, greeting card, or of another desired format that may or may not conform to standards designated by ISO 7810 ID-Type 1.

In one or more embodiments of a stored value item, the item is made of paper, PVC, PET, styrene, polypropylene, Tyvek, metal or other material.

In one or more embodiments of a stored value item, the item is 3 mil to 60 mil thick (75 to 1520 microns).

In one or more embodiments of a stored value item, the NFC element is an NFC chip which is embedded in the item or affixed to the item.

In one or more embodiments of a stored value item, the NFC chip is a passive High Frequency (HF) RFID chip.

In one or more embodiments of a stored value item, the desired machine readable element is an Ultra High Frequency (UHF) chip.

In one or more embodiments of a stored value item, the item contains an HF antenna.

In one or more embodiments of a stored value item, the item contains a UHF antenna.

In one or more embodiments of a stored value item, the item contains more than one machine readable element.

In one or more embodiments of a stored value item, one machine readable element is a passive High Frequency (HF) chip and another machine readable element is an Ultra High Frequency (UHF) chip.

In one or more embodiments of a stored value item, the item contains an HF antenna and an UHF antenna.

In one or more embodiments of a stored value item, the item is usable for payment of goods or services.

In one or more embodiments of a stored value item, the item account is a loyalty account and wherein the stored value is reward points.

In one or more embodiments of a stored value item, the stored value is a rebate or an instant rebate.

In one or more embodiments of a stored value item, the stored value is a purchase credit.

In one or more embodiments of a stored value item, the stored value is a monetary value.

In one or more embodiments of a stored value item, the item's embedded NFC chip is used to identify the item qualifying for a rebate or purchase credit or loyalty incentive.

In one or more embodiments of an item that can be used to access restricted content and/or to obtain stored value, the item comprises:

a) an item identifier;

b) an electronic element affixed to the item or embedded in the item, the electronic element having information encoded thereon that can be read by, transferred to, or shared with an electronic device;

c) an item account associated with the item identifier;

d) an element identifier; and

e) a qualifying action requirement, wherein if the qualifying action requirement is satisfied, access to restricted content is obtained or the stored value is applied to the item account.

In one or more embodiments of an item that can be used to access restricted content and/or to obtain stored value, the electronic element is an NFC chip.

In one or more embodiments of an item that can be used to access restricted content and/or to obtain stored value, the electronic element is a UHF chip.

In one or more embodiments of an item that can be used to access restricted content and/or to obtain stored value, the electronic element is a machine readable element.

In one or more embodiments of a method for providing stored value to an item account based on one or more qualifying actions, the method comprises steps of:

a) providing an item that includes:
i) an item identifier that an item issuer uses to identify the item; and
ii) an electronic element affixed to the item or embedded in the item, the electronic element having information encoded thereon that can be read by, transferred to, or shared with an electronic device, the electronic element having an element identifier;

b) providing an item account associated with the item identifier;

c) linking the item identifier, electronic element, and item account at a remote host;

d) unlocking restricted information on a qualifying action by placing the item in proximity of an NFC enabled device and having the device read the machine readable element; and

e) performing a qualifying action so that a stored value can be applied to the item account.

In one or more embodiments of a method for providing stored value to an item account based on one or more qualifying actions, the item identifier is a machine readable element and wherein in step (d) after the device reads the machine readable element access to a website or software application is unlocked.

In one or more embodiments of a method for providing stored value to an item account based on one or more qualifying actions, the machine readable element of the item provided is a near field communication (NFC) chip, the NFC chip is encoded with an executable code, and wherein the NFC chip supports NFC Data Exchange Format (NDEF) encoding and is operable to deliver the executable code to a NFC enabled device; or a QR bar code; or a claim code; or an RFID; or a UHF chip, or another unique element used by a product manufacturer, distributor, or retailer to identify a product.

In one or more embodiments of a method for providing stored value to an item account based on one or more qualifying actions, the item provided in step (a) is a card, tag, label, letter, greeting card, or other format that may or may not conform to standards designated by ISO 7810 ID-Type 1.

In one or more embodiments of a method for providing stored value to an item account based on one or more qualifying actions, the method further comprises a step of using the item for payment of goods or services.

In one or more embodiments of a method for providing stored value to an item account based on one or more qualifying actions, the item account that is provided is a loyalty account and wherein the stored value is reward points.

In one or more embodiments of a method for providing stored value to an item account based on one or more qualifying actions, the stored value applied to the item is a rebate or an instant rebate.

In one or more embodiments of a method for providing stored value to an item account based on one or more qualifying actions, the stored value applied to the item is a purchase credit.

In one or more embodiments of a method for providing stored value to an item account based on one or more qualifying actions, the stored value applied to the item is a monetary value.

In one or more embodiments of a method for providing stored value to an item account based on one or more qualifying actions, the item's machine readable element to identify whether the item account qualifies for a rebate or purchase credit or loyalty incentive.

In one or more embodiments of a method for providing stored value to an item account based on one or more qualifying actions, the website or app prompts the NFC enabled device to use a camera to scan the machine readable element of the item in order to receive an instant rebate in the form of a credit to the item.

In one or more embodiments of a method for providing stored value to an item account based on one or more qualifying actions, the website or app prompts the NFC enabled device to use a camera to scan the machine readable element of the item in order to receive an instant rebate in the form of a credit to the item account in accordance with terms of an item issuer's program guidelines.

In one or more embodiments of a method for providing stored value to an item account based on one or more qualifying actions, the website or app requires a scan or photo of a purchase receipt to be submitted and verified by the item issuer prior to issuing the stored value.

In one or more embodiments of a method for providing stored value to an item account based on one or more qualifying actions, the stored value issued is a reward or incentive credits.

In one or more embodiments of a method for providing stored value to an item account based on one or more qualifying actions, the website or app requires an item holder of the item to enter purchase specific data manually.

In one or more embodiments of a method for providing stored value to an item account based on one or more qualifying actions, the stored value that is issued is a credit of funds or loyalty credits that are applied to the item account prior to a purchase of a good and wherein the credit of funds occurs after a device's scan of a bar code on the good.

In one or more embodiments of a method for providing stored value to an item account based on one or more qualifying actions, the funds or loyalty credits have a limited expiration period of a few seconds to a few minutes and are restricted for redemption of purchase only of the good scanned and associated with the item account.

In one or more embodiments of a method for providing stored value to an item account based on one or more qualifying actions, the device has a web browser or a device software application that uses GPS coordinates of the device to validate a purchase from an authorized retail location prior to applying the stored value to the item account.

In one or more embodiments of a method for providing stored value to an item account based on one or more qualifying actions, the stored value is a credit or funds that are applied to the stored value account only after the item has been purchased from a merchant and the purchaser performs an action directed by the item provider that prohibits the item from being returned to the merchant for refund.

In one or more embodiments of a method for providing stored value to an item account based on one or more qualifying actions, the credit or funds applied to the stored value account expire once the GPS location of the consumer's device is outside of a retail location where the stored value is offered.

In one or more embodiments, a system for issuing a rebate or purchase credit or other stored value, the system comprising:

a) an item having an embedded or affixed passive High Frequency (HF) chip that supports NFC Data Exchange Format (NDEF) encoding;

b) the chip encoded with content;

c) an item identifier associated with an item account;

d) a chip identifier; and

e) a stored value function wherein stored value is applied to the item account after verifying that one or more requirements are met.

In one or more embodiments of a system for issuing a rebate or purchase credit or other stored value, one of said requirements is that the item be in the presence of a device that can receive encoded information from the item.

In one or more embodiments of a system for issuing a rebate or purchase credit or other stored value, one of said requirements is that a qualifying purchase was made.

In one or more embodiments of a system for issuing a rebate or purchase credit or other stored value, another of said requirements is that a qualifying purchase was made.

In one or more embodiments of a system for issuing a rebate or purchase credit or other stored value, an Ultra High Frequency (UHF) chip is utilized in place of the HF chip.

In one or more embodiments of a system, method and apparatus of the present invention, a frequent flyer card is embedded with or includes one or more embodiments of the technology as described herein (e.g., NFC technology, HF technology, UHF technology, RFID technology, and/or machine readable technology), and the NFC of the carrier's app or website can be used with the frequent flyer card to facilitate a quick conversion of miles to money on a prepaid account associated with the frequent flyer card where basically the card serves dual function for loyalty and payment.

In one or more embodiments of a system, method and apparatus of the present invention, a frequent traveler card is embedded with or includes one or more embodiments of the technology as described herein (e.g., NFC technology, HF technology, UHF technology, RFID technology, and/or machine readable technology), and the NFC of the carrier's app or website can be used with the frequent traveler card to facilitate a quick conversion of miles to money on a prepaid account associated with the frequent traveler card where basically the card serves dual function for loyalty and payment.

In one or more embodiments of the system or method, an item or card may be provided to a recipient without purchase or without the recipient requesting the card.

In one or more embodiments of the system or method, e.g., involving a vehicle test drive, or marketing survey and instant rebates, items or cards can be distributed to random people on the street or by a screened mail list with the hopes of enticing them to facilitate the transaction of having funds loaded to the card or item. The card or item recipients may not have an existing relationship with the issuer or program sponsor and in such a case the card and prospect of load are an inducement for action.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1A is a front view of a card with an HF chip that can be embedded with content for use in a first preferred embodiment of the method of the present invention as depicted in FIG. 10;

FIG. 1B is a side, cutaway view of the card as shown in FIG. 1A;

FIG. 1C is a back view of the card as shown in FIG. 1A;

FIG. 1D is an exploded view of the card as shown in FIG. 1A;

FIG. 2A is a front view of an alternative embodiment of a card with a UHF chip that can be embedded with content for use in a first preferred embodiment of the method of the present invention;

FIG. 2B is a side, cutaway view of the card as shown in FIG. 2A;

FIG. 2C is a back view of the card as shown in FIG. 2A;

FIG. 2D is an exploded view of the card as shown in FIG. 2A;

FIG. 3A is a front view of another alternative embodiment of a card that has both HF and UHF chips that can be embedded with content for use in a first preferred embodiment of the method of the present invention;

FIG. 3B is a side, cutaway view of the card as shown in FIG. 3A;

FIG. 3C is a back view of the card as shown in FIG. 3A;

FIG. 3D is an exploded view of the card as shown in FIG. 3A;

FIG. 4A is a front view of another alternative embodiment of a card that has a combination HF/UHF chip that can be embedded with content for use in a first preferred embodiment of the method of the present invention;

FIG. 4B is a side, cutaway view of the card as shown in FIG. 4A;

FIG. 4C is a back view of the card as shown in FIG. 4A;

FIG. 4D is an exploded view of the card as shown in FIG. 4A;

FIG. 5A is a front view of another alternative embodiment of a card that has a combination HF/UHF chip that can be embedded with content for use in a first preferred embodiment of the method of the present invention;

FIG. 5B is a side, cutaway view of the card as shown in FIG. 5A;

FIG. 5C is a back view of the card as shown in FIG. 5A;

FIG. 5D is an exploded view of the card as shown in FIG. 5A;

FIG. 6A is a front view of another preferred embodiment of a card with an HF chip that can be embedded with content for use in a first preferred embodiment of the method of the present invention as depicted in FIG. 10;

FIG. 6B is a side, cutaway view of the card as shown in FIG. 6A;

FIG. 6C is a back view of the card as shown in FIG. 6A;

FIG. 6D is an exploded view of the card as shown in FIG. 6A;

FIGS. 7A-7G illustrate additional alternative form factors or design embodiments for a card or item that can be used in a first preferred embodiment of the method of the present invention;

FIG. 8A illustrates an open network prepaid card that can be used in second and third preferred embodiments of the method of the present invention as depicted in FIGS. 11 and 12;

FIG. 8B is a side, cutaway view of the card as shown in FIG. 8A;

FIG. 8C is a back view of the card as shown in FIG. 8A;

FIG. 9A illustrates an alternative embodiment of an open network prepaid card that can be used in second and third preferred embodiments of the method of the present invention as illustrated in FIGS. 11 and 12;

FIG. 9B is a side, cutaway view of the card as shown in FIG. 9A;

FIG. 9C is a back view of the card as shown in FIG. 9A;

FIG. 10 is a schematic diagram illustrating a first preferred embodiment of the method of the present invention;

FIG. 11 is a schematic diagram illustrating a second preferred embodiment of the method of the present invention;

FIG. 12 is a schematic diagram illustrating a third preferred embodiment of the method of the present invention;

### DETAILED DESCRIPTION OF THE INVENTION

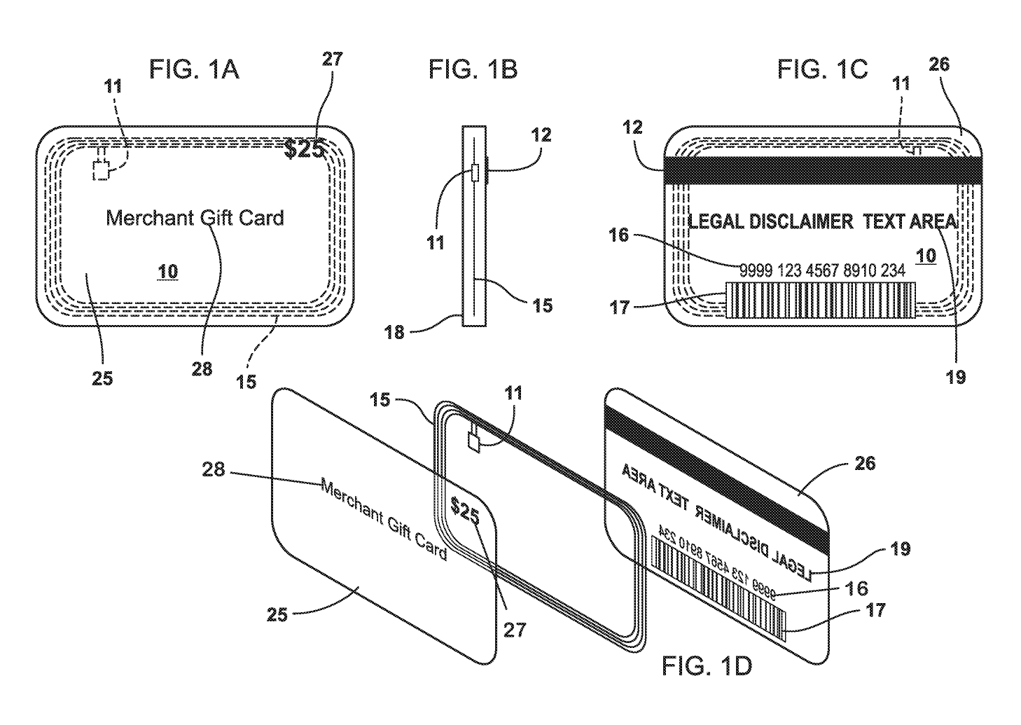

FIGS. 1A-7G illustrate possible embodiments of an item 10 of the present invention that can be used in a first preferred embodiment of the method of the present invention, wherein an item 10 is provided with embedded content, e.g., with embedded media content, or embedded premium media content. Item 10 is sometimes referred to herein as a card or item 10. Item 10 can be a transaction card, payment card, gift card, letter, label, key fob, or other of another desired format/configuration. In the embodiments as shown in FIGS. 1A-7G, a card or item 10 has an embedded NFC chip (e.g., HF chip 11 and/or UHF chip 21). Other NFC elements currently available or to be developed in the future also can be used in one or more embodiments of an item 10.

The NFC chip or other NFC element can be encoded with a link to a website that can verify a qualifying transaction, e.g., purchase of the card or item 10, and can activate premium content, restricted content, or other content encoded on the NFC chip or other NFC element. An NFC chip, or other NFC encoded element, can be a High Frequency chip (HF chip 11) or RFID, Ultra High Frequency chip (UHF chip 21), which can be embedded in an item or card 10 as shown in the examples of some possible different embodiments illustrated in FIGS. 1A-7G. The embedded NFC chip or NFC element is preferably a passive NFC chip or passive NFC element that has NFC Data Exchange Format (NDEF) encoding. It should be understood that the embodiments as shown in FIGS. 1A-7G are examples of item 10 styles, types, configurations and designs that can be embedded with content including various card designs. Other cards or items having different configurations, styles, or designs, that can be embedded with content as described herein, can also be used.

In FIGS. 1A-1D, item 10 is depicted as a card, e.g., a retail/merchant gift card with a card body 18 having a front/face 25, and a back 26. An HF chip 11 and an HF antenna 15 are embedded in card/item 10. HF antenna 15 preferably is tuned to operate in a designated HF frequency range in a passive manner such that the HF antenna is not physically connected to a power source. A value 27 can be included on front/face 25 as shown. A value 27 can also be included on back 26 if desired. Information 28, e.g., designating a merchant, can also be included on front 25 as shown, or on back 26 if desired. A magnetic stripe 12 can also be included on card 10, e.g., on back 26 as shown. A prepaid/debit/account number 16, a bar code 17 for activation or redemption, and/or a legal disclaimer or text area 19 can also be included on item 10, e.g., on back 26 as shown.

Card body 18 can be made of paper, PVC, PET, styrene, polypropylene, Tyvek®, or other suitable material that is preferably about 3 mils to 60 mils thick (75 to 1520 microns). The front 25 and back 26 of body 18 can be opaque or transparent or semi-transparent. An HF antenna 15 and chip 11 inside a contactless card often cannot be seen, and FIGS. 1A and 1C are illustrative and shown with HF antenna 15 and HF chip 11 in phantom view for demonstration purposes. If body 18 however is transparent, then the HF antenna 15 and chip 11 can be visibly embedded inside an item 10 (e.g., as depicted in FIG. 1D, 7). Back 26 is shown as being transparent in the exploded view of FIG. 1D for demonstration purposes.

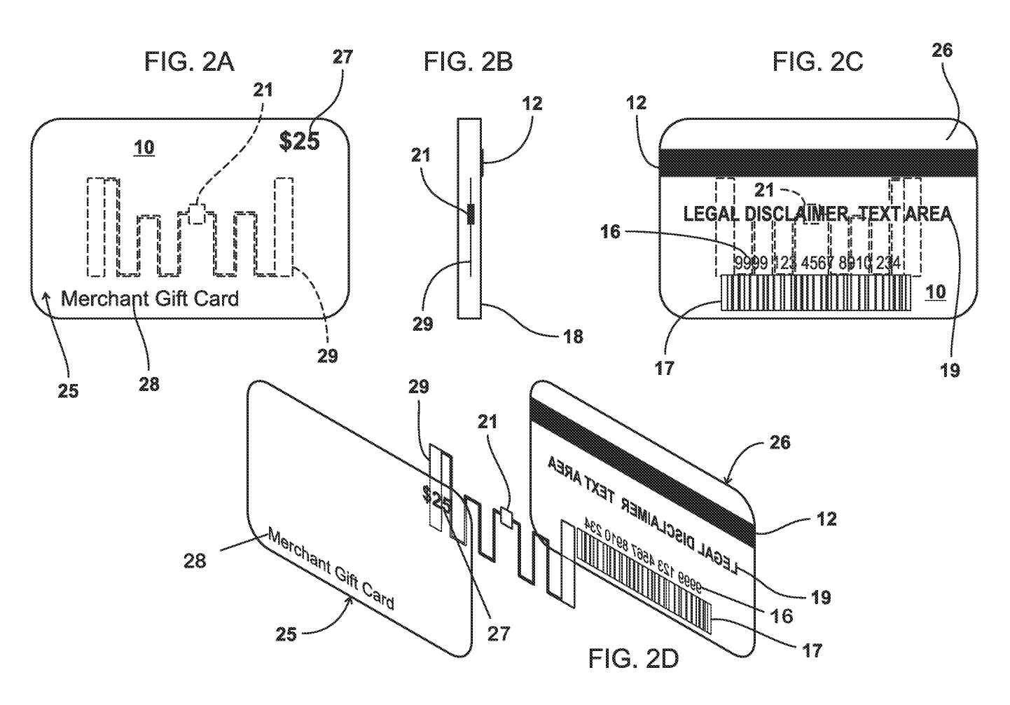

Another embodiment of an item 10 is shown in FIGS. 2A-2D. In this embodiment, item 10 is also depicted as a card, e.g., as a retail/merchant gift card. Instead of having an HF chip 11 and an HF antenna 15 embedded in card/item 10, a UHF chip 21 and a UHF antenna 29 is embedded in the card/item 10. UHF antenna 29 preferably is tuned to operate in a designated UHF frequency range in a passive manner such that the UHF antenna is not physically connected to a power source. Like the embodiment as shown in FIGS. 1A-1D, the card/item 10 can be a retail/merchant gift card with a card body 18 having a front/face 25, and a back 26. A value 27 can be included on front/face 25 as shown. A value 27 can also be included on back 26 if desired. Information 28, e.g., designating a merchant, can also be included on front 25 as shown, or on back 26 if desired. A magnetic stripe 12 can also be included on item 10, e.g., on back 26 as shown. A prepaid/debit/account number 16, a bar code 17 for activation or redemption, and/or a legal disclaimer or text area 19 can also be included on item 10, e.g., on back 26 as shown.

The front 25 and back 26 of body 18 can be opaque or transparent or semi-transparent. The UHF antenna 29 and chip 21 inside a contactless card often cannot be seen, and FIGS. 2A and 2C are illustrative and shown with UHF antenna 29 and UHF chip 21M phantom view for demonstration purposes. If body 18 however is transparent, then the UHF antenna 29 and UHF chip 21 can be visibly embedded inside an item 10. Back 26 is shown as being transparent in the exploded view of FIG. 2D for demonstration purposes.

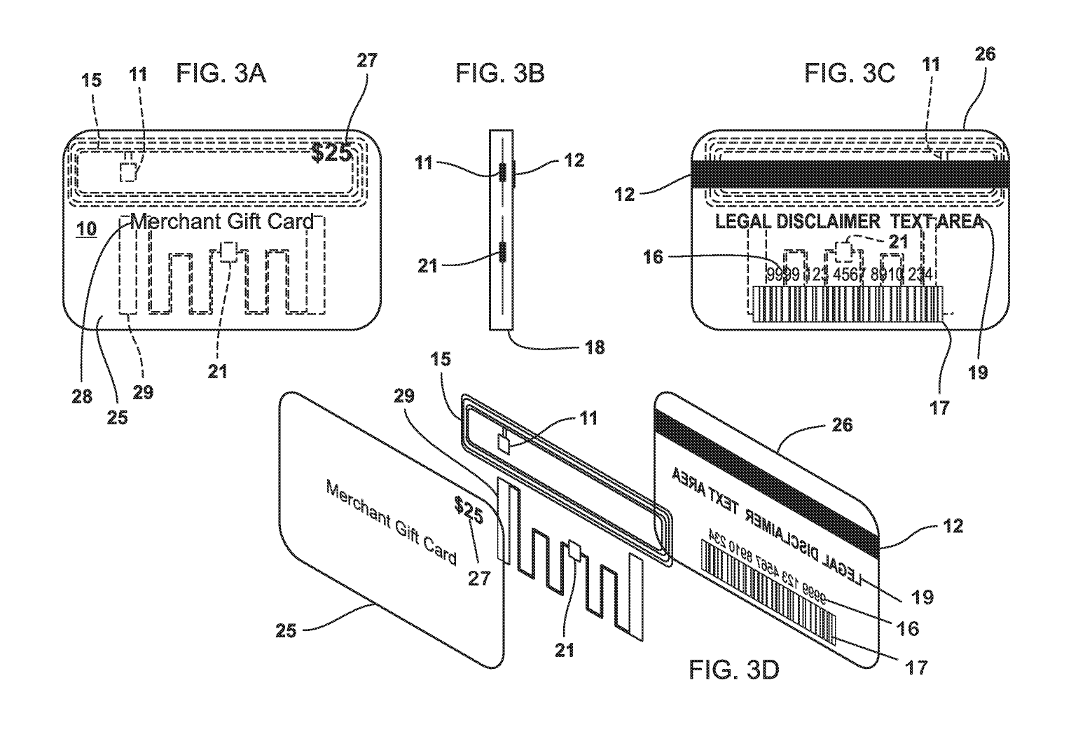

Another embodiment of an item 10 is shown in FIGS. 3A-3D, in which item 10 is also depicted as a card, e.g., as a retail/merchant gift card. In this embodiment, an HF chip 11 and an HF antenna 15, along with a UHF chip 21 and a UHF antenna 29 are embedded in card/item 10. Instead of being located along an inner perimeter of the card/item 10 as shown in FIG. 1A, the HF antenna 15 can be located above the UHF antenna 29 as shown in FIG. 3A. HF antenna 15 preferably is tuned to operate in a designated HF frequency range in a passive manner such that the HF antenna is not physically connected to a power source. UHF antenna 29 preferably is tuned to operate in a designated UHF frequency range in a passive manner such that the UHF antenna is not physically connected to a power source.

Like the embodiments as shown in FIGS. 1A-2D, card/item 10 as shown in FIGS. 3A-3D can be a retail/merchant gift card with a card body 18 having a front or face 25, and a back 26. A value 27 can be included on front/face 25 as shown in FIG. 3A. A value 27 can also be included on back 26 if desired. Information 28, e.g., designating a merchant, can also be included on front 25 as shown, or on back 26 if desired. A magnetic stripe 12 can also be included on item 10, e.g., on back 26 as shown. A prepaid/debit/account number 16, a bar code 17 for activation or redemption, and/or a legal disclaimer or text area 19 can also be included on item 10, e.g., on back 26 as shown.

The front 25 and back 26 of body 18 can be opaque or transparent or semi-transparent. The HF antenna 15 and chip 11, and the UHF antenna 29 and chip 21 inside a contactless card often cannot be seen, and FIGS. 3A and 3C are illustrative and shown with HF antenna 15 and chip 11 and UHF antenna 29 and chip 21 in phantom view for demonstration purposes. If body 18 however is transparent, then HF antenna 15 and chip 11 and UHF antenna 29 and chip 21 can be visibly embedded inside an item 10. Back 26 is shown as being transparent in the exploded view of FIG. 3D for demonstration purposes.

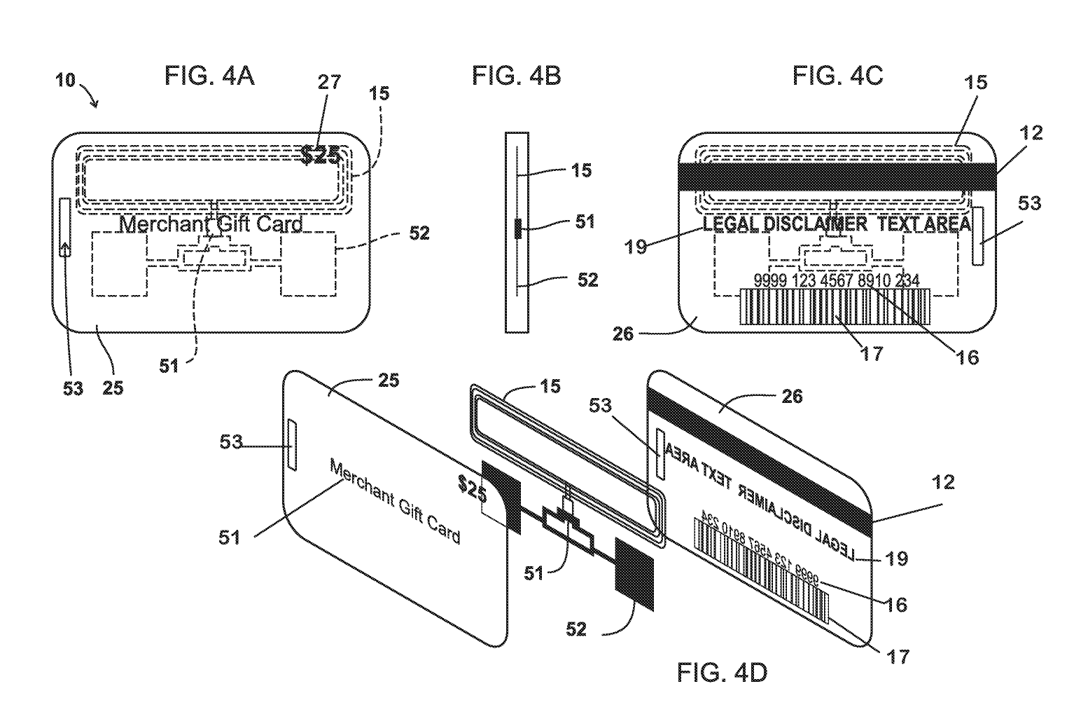

Another embodiment of an item 10 is shown in FIGS. 4A-4D, in which item 10 is also depicted as a card, e.g., as a retail/merchant gift card. In this embodiment, an HF/UHF combination chip 51 is included in card 10 with an HF antenna 15 and a UHF antenna 52. HF antenna 15 preferably is tuned to operate in a designated HF frequency range in a passive manner such that the HF antenna 15 is not physically connected to a power source. UHF antenna 52 preferably is tuned to operate in a designated UHF frequency range in a passive manner such that the UHF antenna 52 is not physically connected to a power source. Chip 51 is a single chip that can function in both HF and UHF frequency ranges with connection to an antenna specific to each frequency.

Like the embodiments as shown in FIGS. 1A-3D, card/item 10 as shown in FIGS. 4A-4D can be a retail/merchant gift card with a card body 18 having a front or face 25, and a back 26. A value 27 can be included on front/face 25 as shown in FIG. 4A. A value 27 can also be included on back 26 if desired. Information 28, e.g., designating a merchant, can also be included on front 25 as shown, or on back 26 if desired. A magnetic stripe 12 can also be included on item 10, e.g., on back 26 as shown. A prepaid/debit/account number 16, a bar code 17 for activation or redemption, and/or a legal disclaimer or text area 19 can also be included on an item 10 as shown in FIGS. 4A-4D, e.g., on back 26.

The front 25 and back 26 of body 18 can be opaque or transparent or semi-transparent. The HF/UHF combination chip 51 and a HF antenna 15 and the UHF antenna 52 in a contactless card often cannot be seen, and FIGS. 4A and 4D are illustrative and shown with HF antenna 15 UHF antenna 52 and HF/UHF combination 51 in phantom view for demonstration purposes. If body 18 however is transparent, then HF antenna 15 and chip 11 and UHF antenna 52 and chip 51 can be visibly embedded inside an item 10. Back 26 is shown as being transparent in the exploded view of FIG. 4D for demonstration purposes.

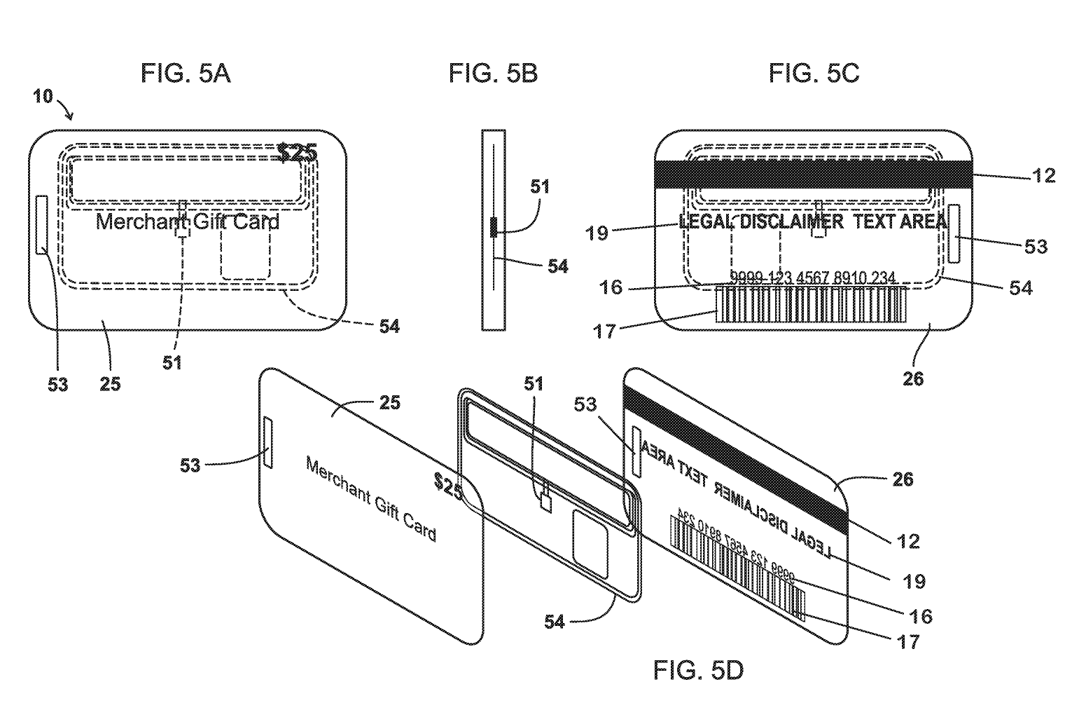

Another embodiment of an item 10 is shown in FIGS. 5A-5D, in which item 10 is also depicted as a card, e.g., as a retail/merchant gift card. In this embodiment, an HF/UHF combination chip 51 is included in card 10 with an HF/UHF combination antenna 54, that can be tuned to operate in a designated HF frequency range in a passive manner such that the HF antenna is not physically connected to a power source, and in a designated UHF frequency range in a passive manner such that the UHF antenna is not physically connected to a power source. Chip 51 is a single chip that can function in both HF and UHF frequency ranges with connection to an antenna specific to each frequency.

Like the embodiments as shown in FIGS. 1A-4D, card/item 10 as shown in FIGS. 5A-5D can be a retail/merchant gift card with a card body 18 having a front or face 25, and a back 26. A value 27 can be included on front/face 25. A value 27 can also be included on back 26 if desired. Information 28, e.g., designating a merchant, can also be included on front 25, or on back 26 if desired. A magnetic stripe 12 can also be included on item 10, e.g., on back. A prepaid/debit/account number 16, a bar code 17 for activation or redemption, and/or a legal disclaimer or text area 19 can also be included on an item 10 as depicted shown in FIGS. 5A-5D, e.g., on back 26.

The front 25 and back 26 of body 18 can be opaque or transparent or semi-transparent. The HF/UHF combination chip 51 and HF/UHF combination antenna 54 in a contactless card often cannot be seen, and FIGS. 5A and 5D are illustrative and shown with HF antenna 15 UHF antenna 52 and HF/UHF combination 51 in phantom view for demonstration purposes. If body 18 however is transparent, then HF/UHF combination chip 51 and HF/UHF combination antenna 54 can be visibly embedded inside an item 10. Back 26 is shown as being transparent in the exploded view of FIG. 5D for demonstration purposes.

The front 25 and back 26 of body 18 can be opaque or transparent or semi-transparent. The HF/UHF combination chip 51 and a HF antenna 15 and the UHF antenna 52 in a contactless card often cannot be seen, and FIGS. 4A and 4D are illustrative and shown with HF antenna 15 UHF antenna 52 and HF/UHF combination 51 in phantom view for demonstration purposes. If body 18 however is transparent, then HF antenna 15 and chip 11 and UHF antenna 52 and chip 51 can be visibly embedded inside an item 10. Back 26 is shown as being transparent in the exploded view of FIG. 4D for demonstration purposes.

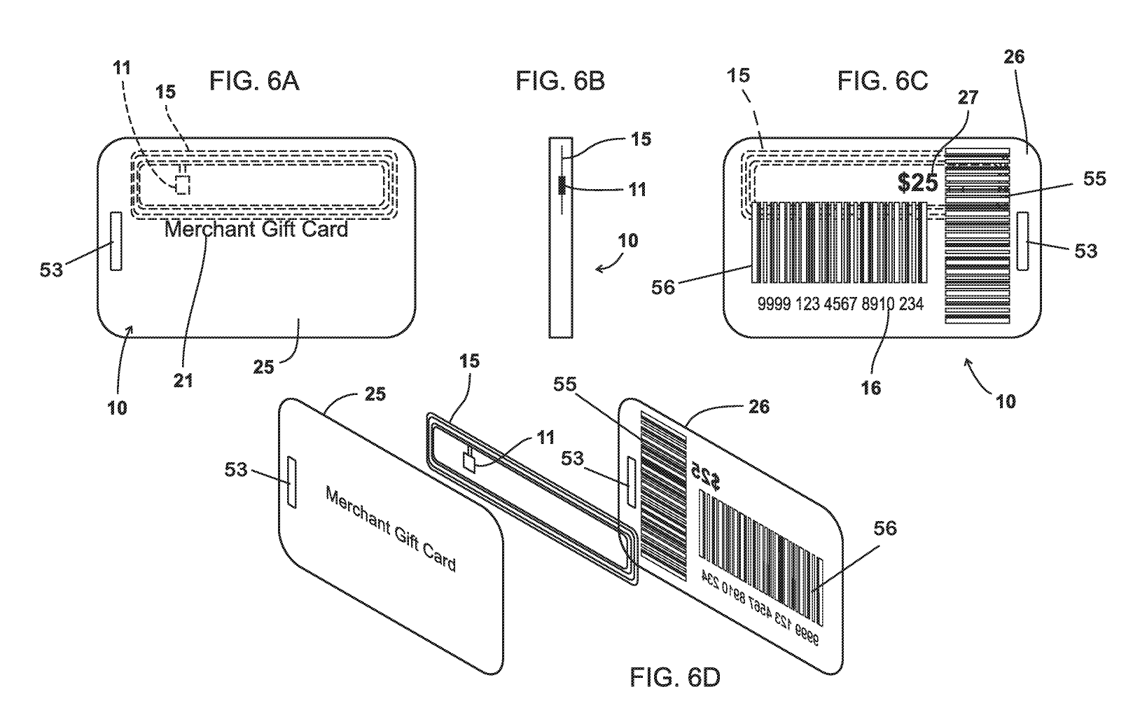

Another embodiment of an item 10 is shown in FIGS. 6A-6D, in which item 10 is also depicted as a card, e.g., as a retail/merchant gift card. In this embodiment, an HF chip 11 and HF antenna is shown. A Quick Response (QR) code having a vertical barcode 55 and horizontal barcode 56 is included on back 26. A QR code can have at least substantially vertical and at least substantially horizontal bar code portions. A QR code including a vertical 55 and substantially horizontal 56 barcode can be read with a QR scanner or reader. An app with a QR code reader can also be downloaded on a smart device 23. A QR code including vertical 55 and horizontal 56 barcode can also be included on any other embodiments of a card 10 or 30 as described herein.

Like the embodiments as shown in FIGS. 1A-5D, card/item 10 as shown in FIGS. 6A-6D can be a retail/merchant gift card with a card body 18 having a front or face 25, and a back 26. A value 27 can be included on front/face 25. A value 27 can also be included on back 26 if desired. Information 28, e.g., designating a merchant, can also be included on front 25, or on back 26 if desired. A magnetic stripe 12 can also be included on item 10, e.g., on back. A prepaid/debit/account number 16, a bar code 17 for activation or redemption, and/or a legal disclaimer or text area 19 can also be included on an item 10 as depicted shown in FIGS. 6A-6D, e.g., on back 26.

The front 25 and back 26 of body 18 can be opaque or transparent or semi-transparent. The HF chip 11 and HF antenna 15 in a contactless card often cannot be seen, and FIGS. 6A and 6D are illustrative and shown with HF antenna 15, HF chip 11 in phantom view for demonstration purposes. If body 18 however is transparent, then HF chip 11 and HF antenna 15 can be visibly embedded inside an item 10. Back 26 is shown as being transparent in the exploded view of FIG. 6D for demonstration purposes.

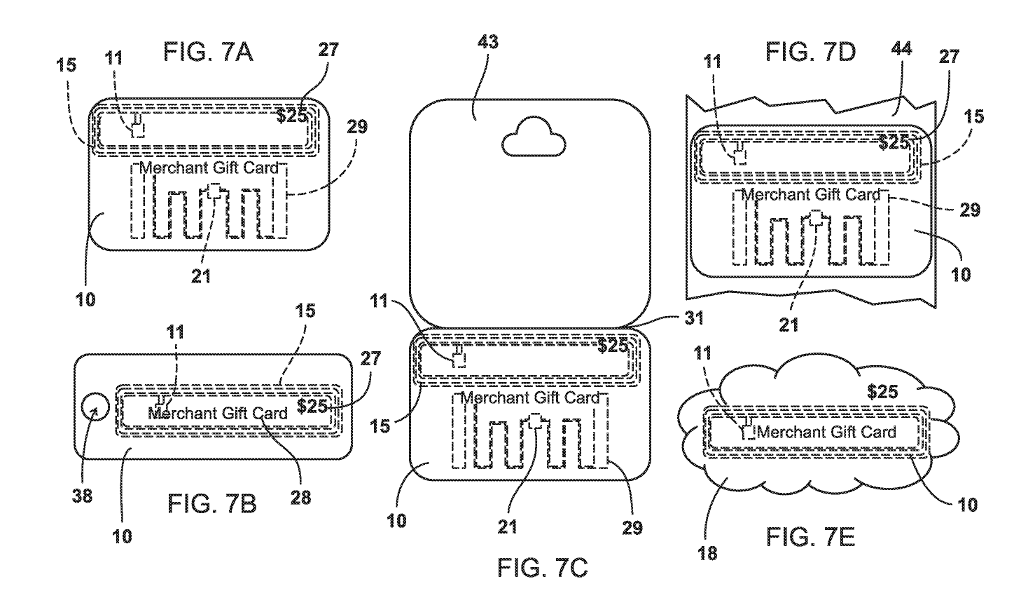

FIGS. 7A-7G illustrate additional form factors and embodiments for an item 10. It should be understood that in any of the illustrated form factors/embodiments of FIGS. 7A-7G, an item 10 can have an HF chip 11 and HF antenna 15 or a UHF chip 21 and UHF antenna 29. In any of the illustrated form factors, a card or item 10 can also have both an HF chip 11 and an HF antenna 15, and a UHF chip 21 and a UHF antenna 29. In the various embodiments as shown and described, an HF chip 11 and/or UHF chip 21 of a card or item 10 can be embedded in the card or item 10 in a location as desired. The size of an HF antenna 15 and a UHF antenna 29 can be selected based on the size and dimensions of the item format/configuration to be utilized.

FIG. 7A illustrates a standard card format for an item 10, e.g., as shown in FIGS. 3A-3D, which can be a retail/merchant gift card. The embodiments as shown in FIGS. 1A-1D, FIGS. 2A-2D, FIGS. 4A-4D, FIGS. 5A-5D and FIGS. 6A-6D are also considered to be a standard card format. FIG. 7B illustrates a key fob format for an item 10 having an HF chip 11 and an HF antenna 15. A value 27 and information 28 may also be included on item 10 in key fob format. An opening 38 can be present in the key fob format, for receiving a key chain ring, for example. A key fob format for an item 10 can also include other chip/antenna combinations as desired, e.g., as shown in FIGS. 1A-6D.

FIG. 7C illustrates a retail hang tag format for an item 10 having an HF chip 11 and an HF antenna 15, as well as a UHF chip 21 and a UHF antenna 29. The item 10 as illustrated can be the same or similar to an embodiment as shown in FIGS. 1A-6D and it can be removably affixed to a hang tag 43, e.g., at tear line, perforation, or break line 31. Any other embodiment of an item 10 as shown and described herein can also be used in a retail hangtag format.

FIG. 7D illustrates a label format for an item 10, e.g., for affixing the item 10 onto a greeting card, or a mobile device, or a gift bag or box, or to another desired surface after removing label portion 44. The item 10 can be the same or similar to an embodiment as is shown in FIGS. 1A-6D. Any other embodiment of an item 10 as shown and described herein can also be used in a label format. Label portion 44 can have an adhesive affixed thereto via which the card or item 10 can be attached to the card, phone, or other desired surface. Preferably, the item 10, once removed from the label, can be removably affixed to a desired surface.

FIG. 7E illustrates a free form card format for an item 10 having an HF chip 11 and an HF antenna 15, in which the card body 18 has a cloud like shape. Any other desired shape for a card body 18 an also be used. A free form card format for an item 10 can also include other chip/antenna combinations as desired, e.g., as shown in FIGS. 1A-6D.

FIG. 7F illustrates a greeting card format for an item 10 having an HF antenna 15 and HF chip 11. In this embodiment, a greeting card 46 has a front page 45 and a back page 47. The item 10 body 18 is integral with back page 47, such that body 18 is part of back page 47 with front/face 25 of body 18 being a front surface of back page 47 and back 26 of body 18 being a back surface of back page 47. In a gift card format, item 10 could also be integral with front page 45 of a greeting card 46. A greeting card format could also have a single page. A greeting card format for an item 10 can also include other chip/antenna combinations as desired, e.g., as shown in FIGS. 1A-6D.

FIG. 7G illustrates a standard letter or A4 format for an item 10 having an HF antenna 15 and HF chip 11. In this embodiment as shown, a letter or A4 format 48 can alternatively be of a size similar to a post card, greeting card, or note card, and it can be provided to a recipient. The item 10 body 18 is integral with the letter/A4 form 48, such that the item body 18 is part of letter/A4 form 48. A text/message 50 from a merchant, marketing firm, or other program sponsor, can be included on the prepaid card brand as shown. Instructions 49, such as “Tap here with NFC mobile device”, can be included over the area that the HF chip 11 and HF antenna 15, and/or UHF chip 21 and UHF antenna 29 are located. Front/face 25 of body 18 is part of a front surface of letter/A4 format 48 and back 26 of body 18 is part of a back surface of letter/A4 format 48. A standard letter or A4 format for an item 10 can also include other chip/antenna combinations as desired, e.g., as shown in FIGS. 1A-6D.

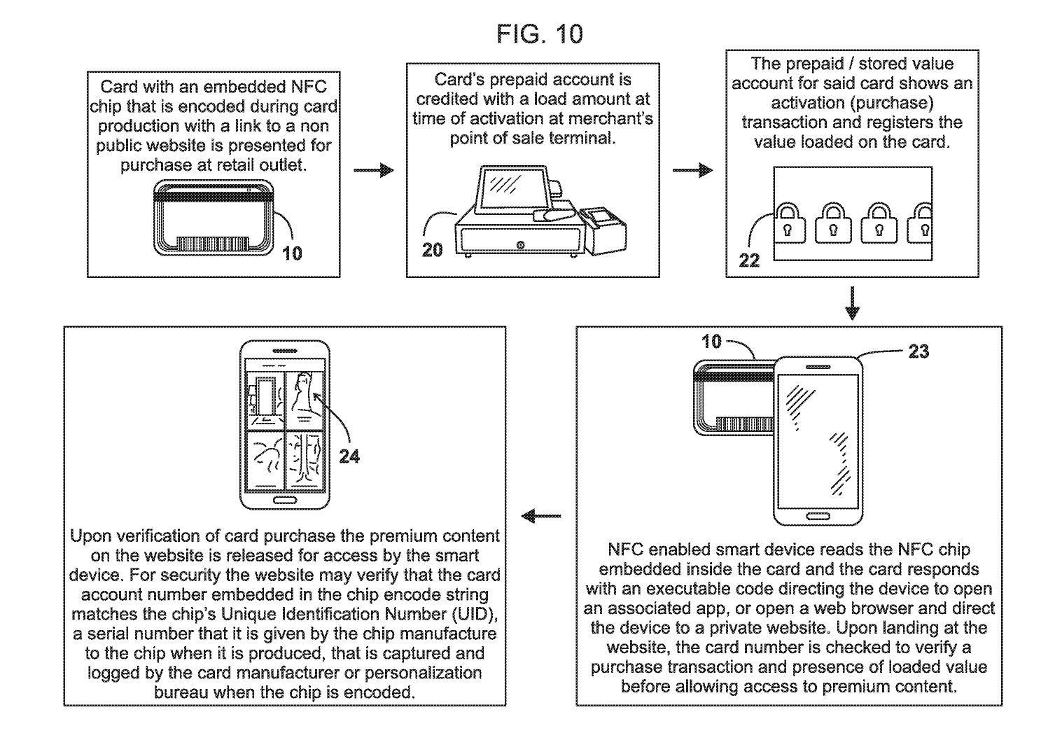

FIG. 10 is a schematic diagram illustrating a first preferred embodiment of the method of the present invention involving access to premium or restricted media content. In FIG. 10, an item 10 of the embodiment of FIGS. 1A-1D is shown for use with a method directed to providing access to premium or restricted content. Other embodiments of an item 10 as shown and described herein, e.g., as shown in FIGS. 1A-7G, can also be used with the method as shown in FIG. 10.

In the embodiment of FIG. 10, the method includes the following steps.
1) An item 10 (which is in a standard card format with an embedded NFC chip or NFC element, e.g., HF chip 11 that is encoded during card production with a link to a non-public website) is presented for purchase at a retail outlet or merchant's place of business.
2) The item 10, also having a prepaid/stored value account associated therewith, is credited with a load amount at the time of activation at the merchant's/retail outlet's point of sale terminal 20.
3) The prepaid/stored value account for said item 10 shows an activation (purchase) transaction and registers the value loaded on the item 10.
4) An NFC enabled smart device 23, e.g., a tablet or a smart phone 23, reads the NFC chip embedded inside item 10 and the item 10 responds with an executable code directing the smart device 23 to open an associated app, or to open a web browser and direct the smart device 23 to a private website, and wherein upon landing at the private website, the item 10 account number or identifier 16 is checked to verify the purchase transaction and/or the presence of loaded value before allowing access to premium content/restricted content 24.
5. Upon verification of the item 10 purchase, the premium content/restricted content on the website is released for access by smart device 23, and wherein, for security, the website may verify that the account number or identifier 16 encode string embedded in the NFC chip matches the NFC chip's Unique Identification Number (UID), which can be a serial number or other unique identifier that is given by the chip manufacturer to the NFC chip when it is produced, and that is captured and logged by the card manufacturer or personalization bureau when the NFC chip is encoded.

In one or more embodiments of the method as shown in FIG. 10, the item 10 with the NFC chip, e.g., HF chip 11, can be activated upon purchase at a point of sale terminal 20. In the embodiment as shown in FIG. 10, purchase of the item 10 is a qualifying transaction.

The purchase transaction is recorded for the item 10 on a secure site or secure server 22. Secure site or secure server 22 can be a remote host or a remote database. Although it is possible that such a site or server would not be secure, given that a payment transaction is involved, preferably the site or server is secure.

A smart device 23 in the presence of item 10 can then read the NFC chip or NFC element, e.g., HF chip 11 that is encoded with a link to a website, or to an associated app, and is directed to the website or app. Upon landing at the website, the card or item 10 account identifier or account number 16 is checked to verify purchase before allowing access to the premium content or restricted content, which is represented by numeral 24 in FIG. 10.

Upon verification of the qualifying transaction, e.g., purchase of item 10 and also possibly verification of loaded value on the item 10, the premium content or restricted content 24 on the website is released for viewing by the smart device 23.

In other embodiments, an item or card 10 with an NFC chip or other NFC element potentially could be activated at a time other than the point of sale, e.g., through an NFC enabled mobile device equipped with an application for transaction processing.

In one or more embodiments, the NFC chip or other NFC element of the card can be encoded with information directing the user to an app or to a website.

In one or more embodiments, the NFC chip or other NFC element of the card can be encoded with premium or restricted content.

In one or more embodiments of the method as shown in FIG. 10, the card or item 10 can be a gift card.

In one or more embodiments of the method as shown in FIG. 10, the card or item 10 can be a stored value prepaid card

In one or more embodiments of the method as shown in FIG. 10, the card or item 10 can be a payment card.

In one or more embodiments of the method as shown in FIG. 10, the card or item 10 can be a transaction card.

In general, gift cards have become a mature market and the once double-digit year over year sales growth rate has slowed to more modest single digit year over year growth. Merchants who experienced the power of gift card sales continue to push for new ways to grow sales of their gift card and drive incremental sales growth. Recent trends in card marketing have been to leverage higher end card design finishes such at tactile features, non-traditional card materials like metal and wood, and the addition of gift with purchase with items in sophisticated point of sale packaging. For merchants that try these approaches there is a lot of time and expense for what are ultimately short-lived, often seasonal, campaigns.

The embodiment as shown in FIG. 10 of the present invention, for example, takes the gift with purchase concept to a different and novel level as it leverages passive NFC chip technology in a card or item 10 to direct a smart device 23, e.g., a smartphone or tablet, to a remotely hosted website where premium and/or restricted content is stored and only made available to smart devices 23 in the presence of card or item 10, e.g., a gift card, or other stored value prepaid card, or payment card, and only after verification of a qualifying event for the specific card or item 10, e.g., that it has been purchased through a retail transaction.

In various embodiments, the NFC technology in the card or item 10 allows for a number of deployment variations that preferably center around controlling access to a premium multimedia experience available to the card holder on a remote server such that the content is accessible only to issuer specific cards or items 10 that:

1) contain an NFC chip or NFC element with NFC Data Exchange Format (NDEF) encoding that directs the NFC enabled device to a specific website;

2) use data in the NDEF payload to enable the remote server to query a database to verify a purchase transaction for the stored value payment card through a payment network (closed or open); and 3) are able to verify the card account associated with the card's NFC chip or NFC element has been purchased through a retail transaction.

Goals of the embodiment as shown in FIG. 10 include to:

1) restrict access to premium web content or restricted content 24 only to purchased cards or items 10 and prevent the premium or restricted content 24 from being accessed by cards or items 10 that are scanned prior to purchase either while in exposed retail shelving or by retailer internal theft;

2) prevent access to the premium site/private site by viral spread of the website data being scanned and posted to social media;

3) create exclusivity through limited quantity production runs of cards or items 10 that can act as keys to access specific sites for theme-related content; and/or

4) generate additional usage of the card or item 10 by requiring a minimum balance on the card account to maintain access to the site or premium content 24 or have established tiers of access based on the amount of money loaded on the card or item 10 with higher levels of access to cards or items 10 with higher dollar load amounts.

In preferred embodiments, the NFC enabled card or item 10 with verified purchase creates a highly personalized card or item 10 that is able to access premium media content through a smart device's 23 NFC technology. Examples include video, games and other premium web content.

In various embodiments a card or item 10 is a payment card that can be made from rigid plastic, PVC, PET, styrene, polypropylene, Tyvek®, or other synthetic material, or other desired material, e.g., metal.

A card or item 10 that is in a payment card format, or a gift card, for example can be about 7 mils to 60 mils thick (175 to 1520 microns). Preferably, a card or item 10 that is a payment card or gift card is made of PVC or PET and is about 10 to 30 mils (250 to 760 microns) thick. If another form for item or card 10 is provided such as a letter, preferably the item is made of paper (natural or synthetic) and is about 5 to 15 mils (125 to 380 microns) thick. If another form for item or card 10 is provided such as a greeting card, preferably the greeting card is made of paper, Tyvek, or OPP (Oriented PolyPropylene) and is about 7 to 24 mils (175 to 610 microns) thick. If another form for item or card 10 is provided such as a label, preferably the label is made of paper, Tyvek, OPP, synthetic paper and is about 7 to 15 mils (175 to 380 microns) thick. If another form for item or card 10 is provided such as a tag, preferably the tag is made of paper or plastic and is about 10 to 60 mils (250 to 1520 microns) thick.

Preferably, a card or item 10 that is a payment card conforms to ISO 7810 ID-Type 1 form factor, or to other known similar standards or similar standards to be developed in the future. Preferably, a card or item 10 that is a payment card has a passive High Frequency (HF) NFC chip 11, e.g., embedded or affixed thereto, that supports NFC Data Exchange Format (NDEF) encoding. Alternatively, the card or item 10 may have a UHF chip 21 or both chip types 11, 21 as supported by expanded capabilities of the chip technology to be adapted for this application.

Preferably, a card or item 10 that is a payment card has an assigned identifier or account number 16, e.g., a credit, debit, or prepaid debit account number, that is capable of being used for payment of goods or services. The identifier or account number 16 can be imaged on the surface of the card or item 10, e.g., on front 25 or back 26 of card or item 10, e.g., using inkjet, thermal transfer, laser, or other commercially available variable imaging process, or other similar process to be developed in the future.

Preferably, a card or item 10 that is a payment card has an NFC payment chip, e.g., an HF chip 11 or UHF chip 21, or both, has a Unique Identification Number (UID), or other unique identifying element that is linked to the item's 10 identifier or account number 16, which can be used with payment, in a remote host, e.g., a remotely hosted database with an association being made to the item's 10 Unique Identification Number (UID), or other unique identifying element that is encoded into the NFC chip's memory. An HF chip and/or UHF chip, encoded using NFC Data Exchange Format (NDEF), is preferably encoded to deliver an executable code that directs the cardholder's smart device 23, e.g., a smartphone, tablet, or other NFC enabled device, to the premium/restricted content 24, e.g., to a specific website or app that contains content restricted from general audiences and which preferably is only accessible by said smart device 23, e.g., a smartphone, tablet, or other NFC enabled device, in the presence of a card or item 10 designated by the issuer to have access to the site's premium/restricted content 24 only after validating the card or item 10 has been purchased or received a credit through a qualifying retail load transaction.

In some embodiments, content restricted from general audiences can be accessible by said smart device 23, e.g., a smartphone, tablet, or similar NFC enabled device, in the presence of a card or item 10.

In other embodiments, content restricted from general audiences can be accessible by said smart device 23, e.g., a smartphone, tablet, or similar NFC enabled device, in the presence of a card or item 10 and after validating that a qualifying, or activating or triggering event has occurred.

In other embodiments, content restricted from general audiences can be accessible by said smart device 23, e.g., a smartphone, tablet, or similar NFC enabled device, after validating that a qualifying, or activating or triggering event has occurred.

In various embodiments, the website can verify that the account identifier or number 16 of the card or item 10, e.g., of a payment or gift card, transmitted in the NDEF data stream corresponds with the UID of the NFC chip or NFC element of the card.

In various embodiments, the website can verify purchase information.

Verification of purchase by the website can include an account balance inquiry that can be used to restrict access to content on the basis of account balance, account activity, specific products purchased with said card or item 10, and/or other account specific criteria.

Verification of purchase by the website can include an account balance inquiry that can be used to restrict access to content on the basis of account balance, account activity, specific products purchased with said card or iteml0, and/or other account specific criteria that are established by the card issuer and that are in accordance with the terms and conditions of the account as issued or published by the issuer at the time the card or item 10 is sold or conveyed to the initial recipient of the card or item 10.

In various embodiments, the website can capture the identifier or account number 16 of the card or item 10, the UID of the NFC chip or element, or other uniquely identifiable element, and use at least one of the identifying elements in addition to the purchase transaction, to convey to the card issuer that the cardholder has watched a video, completed a survey, or performed a task requested by the issuer as a condition for crediting the account of the card or item 10 with subsequent activity required to access premium content.

Examples of applications of a transaction card or item 10 in the embodiment of FIG. 10 include the following.

1) Purchasing a gift card to a theatre chain and inside is a chip that is programmed to take the cardholder to a special URL that unlocks exclusive director cuts from the most recent blockbuster movie, or a trailer for an upcoming feature film.

2) Purchasing a gift card from a home improvement store that has a garden theme and the recipient can use the NFC technology associated with the gift card to access an exclusive video on gardening tips.

3) Purchasing a gift card from a sports store that is basketball-themed and the card takes the cardholder to an exclusive video of an NBA player giving tips on shooting techniques.

4) Purchasing a gift card for a grocery chain or kitchen gadget retailer that takes the cardholder to a site with exclusive recipes with celebrity chefs showing the cardholder how to prepare the dish.

5) Purchasing a gift card for a cosmetics retailer with links to exclusive video showing tips for using makeup or hair styling products, perhaps one targeted at teens who need guidance on how to fight acne.

6) Purchasing a gift card for an electronics or box retailer that targets gamers where the card's NFC gives the cardholder access to advance releases on hot new games, or, if made game-specific, gives access to new levels or hidden scenes. Also, it could allow access to a site for download of exclusive music not available through traditional music stores.

As can be seen, a card or item 10 of the embodiment of FIG. 10 can be used in countless desired applications based on different target markets and marketing goals.

In various embodiments, a card or item 10, e.g., a transaction card, can be purchased or otherwise acquired by an end user.

In various embodiments, a card or item 10, e.g., a transaction card, can be purchased or otherwise acquired by a first user, who can then convey the card to another end user who can then access the restricted content.

In some embodiments, access to restricted content can be available when the card or item 10, which can be a standard form transaction or payment card or of another form, such as a letter, greeting card, tag, or other format, is in the presence of a smart device 23.

In other embodiments, access to restricted content can be available when the card 10, which can be a standard form transaction or payment card or of another form, such as a letter, greeting card, tag, or other format is in the presence of a smart device 23 and after a qualifying event, activity or trigger occurs.

In other embodiments, content restricted from general audiences can be accessible by said smart device 23, e.g., a smartphone, tablet, or similar NFC enabled device, after validating or confirming that a qualifying, or activating or triggering event has occurred.

In various embodiments the website or app can verify that the card or item 10 identifier or account number 16 transmitted in the NDEF data stream corresponds with a UID of the chip embedded in or affixed to said card or item 10.

In various embodiments, the website or app can verify a purchase.

Verification of purchase by the website can include an account balance inquiry that can be used to restrict access to content on the basis of account balance, account activity, specific products purchased with said item or card 10, or other account specific criteria established by the issuer.

Verification of purchase by the website can include an account balance inquiry that can be used to restrict access to content on the basis of account balance, account activity, specific products purchased with said item, or other account specific criteria established by the issuer, that is preferably in accordance with terms and conditions of the account as published or otherwise set forth by the issuer at the time the card or item 10, which can be a standard form transaction or payment card or of another form, such as a letter, greeting card, tag, or other format sold or otherwise conveyed to the initial recipient of the card 10 or another item, letter, greeting card, tag, or other format.

In various embodiments, the website or app can capture the item's 10 identifier or account number, UID, or other uniquely identifiable element, and use at least one of the identifying elements to convey to the issuer that the cardholder has watched a video, completed a survey, selected crediting the card as an exchange for another award from a loyalty program, or performed a task requested by the issuer as a condition for crediting the item's 10 associated account with funds, purchase credits, purchase units, or other form of stored value. The item 10 can be a standard form transaction or payment card or of another form, such as a letter, greeting card, tag, or of another desired format.

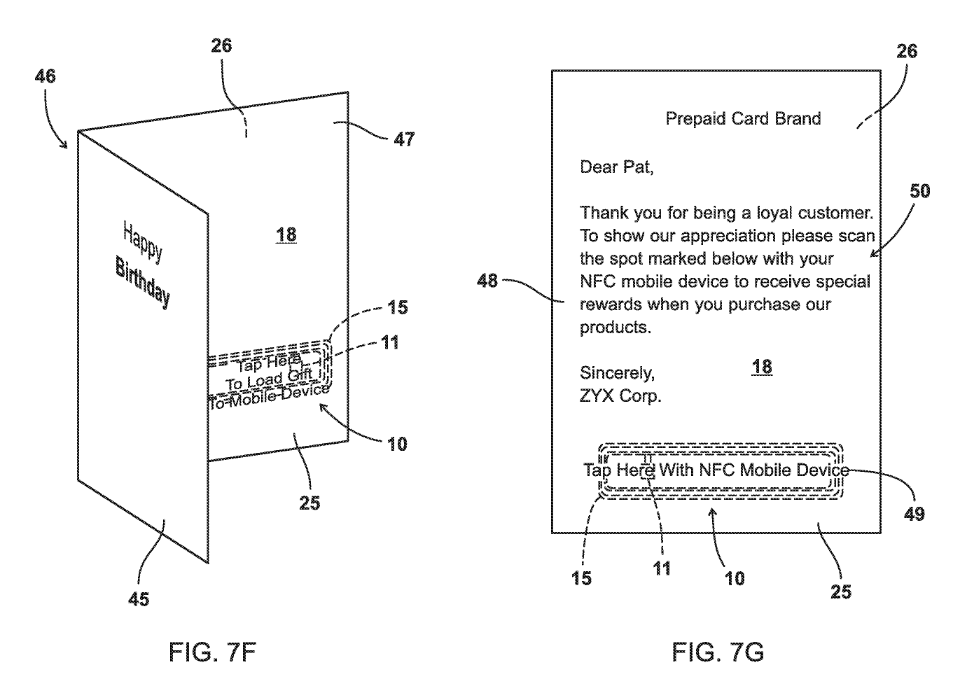

Turning now to FIGS. 8A-9C and FIG. 11, a second preferred embodiment of the method of the present invention in which a transaction card 30 with embedded premium content can be used as a stored value account is illustrated and discussed.

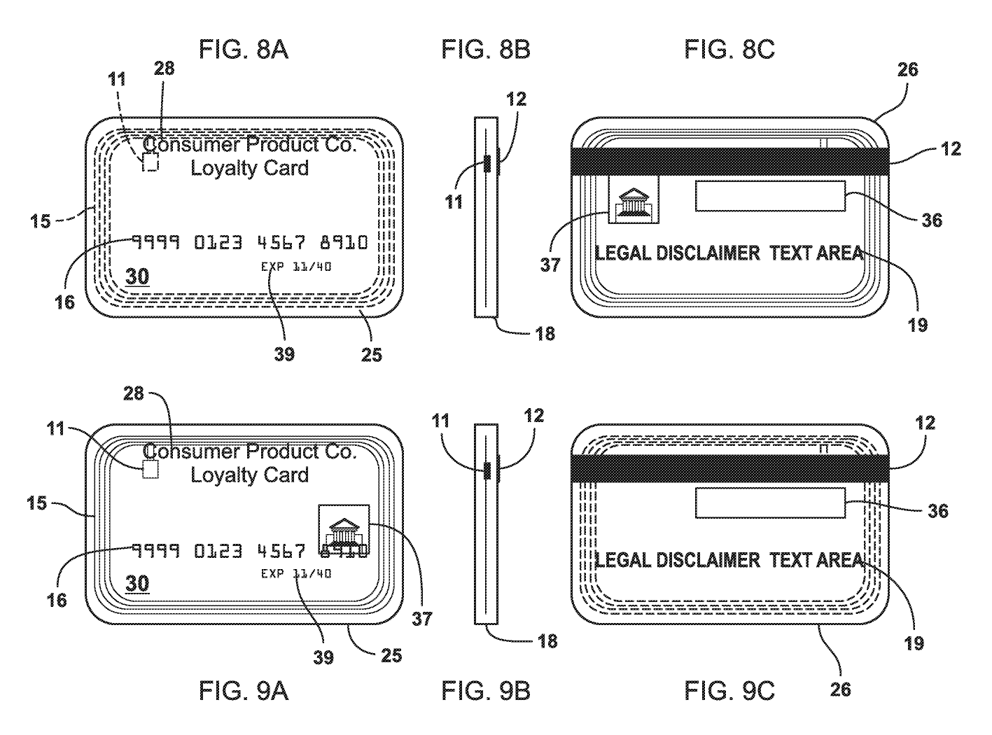

In FIGS. 8A-9C, an item 30 is illustrated with an embedded NFC chip. Item 30 is in standard card format and can be a pre-paid debit card. In the embodiment of FIGS. 8A-9C, the NFC chip is an HF chip 11, and an HF antenna 15 is also embedded in card or item 30. HF chip 11 is encoded with a link to a website that the cardholder is required to visit and perform specified activities prior to the card account being loaded with funds, credits, or other forms of stored value.

It is noted that currently available mobile phones are designed to read/write/be used with HF/NFC technology. Typically, with the limited space inside mobile phones, the mobile phone manufacturers only incorporate hardware for NFC/HF communication. Other NFC and RFID elements that are currently available or that will be developed in the future can also potentially be included in a card 30 and/or a card 10 for use with NFC or RFID technology of a mobile phone or other smart device, e.g., NFC technology that is currently available or to be developed in the future for mobile phones and other smart devices. The functionality of said technology shall not be limited to just that of the physical constraints of the device itself, but may be accessible through an extension of the smart device that is created by a separate and distinct unit that connects to the device by cable, Low Energy Blue Tooth (BLE), or other currently available or yet to be developed means of connecting an ancillary unit to a smartphone, tablet, or similar device.

An item 30 is sometimes referred to herein as an item or card 30. An item 30 can have body 18 having a front/face 25, and a back 26. An HF chip 11 and an HF antenna 15 are embedded in item 30 in a similar manner as shown in FIGS. 1A-1D. A prepaid/debit/account number 16 can be included on front 25. Although not shown, a prepaid/debit/account number 16 can also be included on back 26. Information 28, e.g., designating a merchant, can also be included on front 25 along with an expiration date 39. Information 28 can also be included on back 26 along with an expiration date 39. A magnetic stripe 12 can be included on item 30, e.g., on back 26. A signature panel 36 can also be included on item 30, e.g., on back 26. A legal disclaimer or text area 19 can also be included on item 30, e.g., on back 26 as shown. A network branding/security hologram 37 can be included on back 26 as shown in FIGS. 8A-8C or on front/face 25 as shown in FIGS. 9A-9C.

A card or item 30 body 18 can be made of paper, PVC, PET, styrene, polypropylene, Tyvek®, or other suitable material that is about 3 mils to 60 mils thick (75 to 1520 microns). The front 25 and back 26 of body 18 can be opaque or transparent or semi-transparent.

An NFC chip, or other NFC encoded element, can be embedded in the card at the time of manufacture or distribution. An NFC chip or other NFC element can also be deployed in other form factors/item configurations as shown in FIGS. 7A-7G. The NFC chip or NFC element is preferably a passive NFC chip or element. The NFC chip or element is preferably an NFC chip or element with NFC Data Exchange Format (NDEF) encoding.

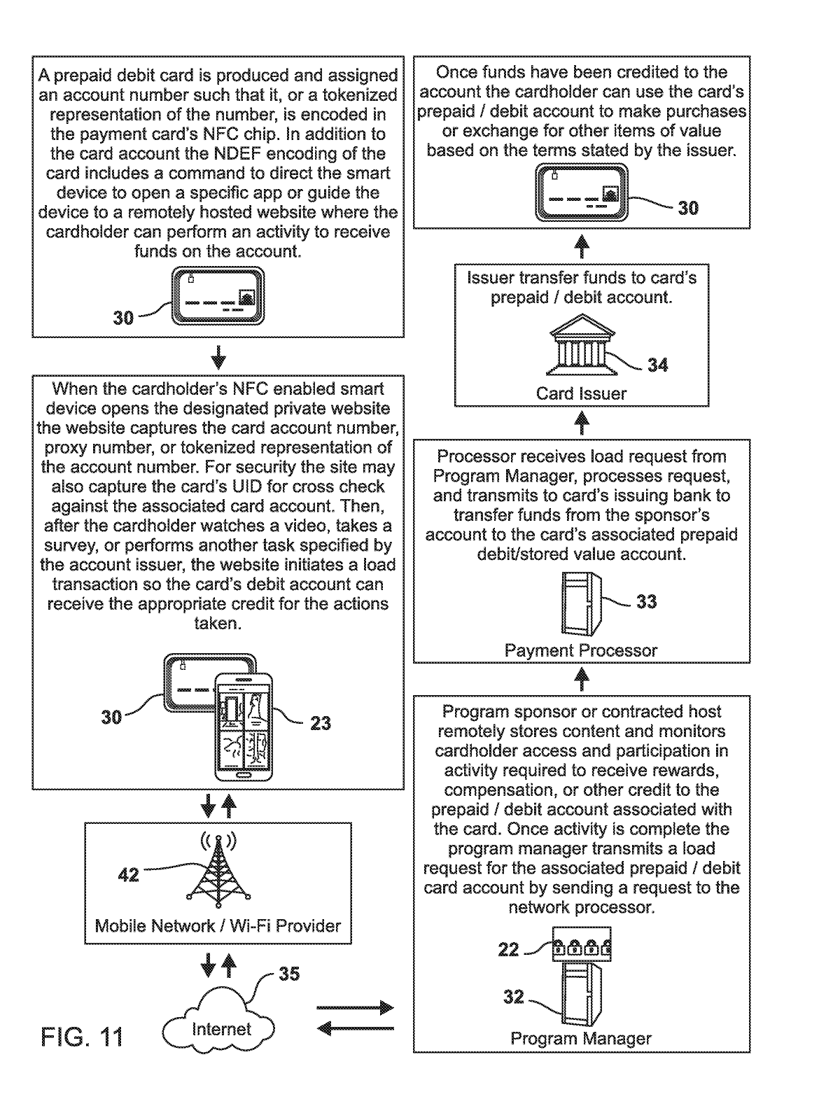

FIG. 11 is a schematic diagram showing a second preferred embodiment of the method of the present invention directed to verification and reward for consumer participation. In FIG. 11, an item 30 as illustrated in FIGS. 9A-9C is shown by way of example. Other embodiments of item 30 as described and shown herein can also be used in the method of FIG. 11.

In the embodiment of FIG. 11, the method includes the following steps.

1. A card or item 30, e.g., a prepaid debit card, stored value card, payment card or other transaction card, is produced and assigned an account number or identifier 16 associated with a card or item 30 account, such that it, or a proxy number, or a tokenized representation of the account number or identifier 16, is encoded in the NFC chip of the card or item 30, and wherein in addition to the card account number or identifier 16, the NDEF encoding of the card or item 30 includes a command to direct a smart device 23 to open a specific app, or to guide the device to a remotely hosted website, where the cardholder can perform an activity to receive funds on the account associated with the card or item 30.

2. When the cardholder's NFC enabled smart device 23, e.g., a smart phone, tablet, or other NFC enabled device, opens the designated private website, the website captures the account number or identifier 16 of card or item 30 (or a proxy number, or a tokenized representation of the account number or identifier 16) and wherein, for security, the site may also capture the card's UID, e.g., a UID of an NFC chip or NFC element of the card, for cross checking against an associated card account, and wherein, after the cardholder watches a video, takes a survey, or performs another task specified by the account issuer, the website initiates a load transaction so the account associated with the card or item 30, which can be a prepaid debit/stored value account, can receive the appropriate credit for the actions taken.

3. A program sponsor, program manager, or contracted host (represented by the number 32) remotely stores content at a secure site or server 22 and monitors cardholder access and participation in activity required to receive reward, compensation, or other credit to the account, e.g., a prepaid /debit account, associated with the card or item 30, and wherein once activity is complete the program sponsor, program manager, or contracted host transmits a load request for the associated account, e.g., a prepaid/debit card account, by sending a request to the network processor.

4. A network processor or payment processor 33 receives a load request from the program sponsor or manager 32, processes the request, and transmits to an issuing bank (e.g., a card issuer 34) of the card or item 30 instructions to transfer funds from the account of the program sponsor or manager 32 to the account of the card or item 30, e.g., an associated prepaid debit/stored value account.

5. An issuer transfers funds to the account associated with the card or item 30, e.g., a prepaid/debit account or prepaid debit/stored value account.

6. Once funds have been credited to the account the cardholder can use the account of the card or item 30, which can be a prepaid/debit account or prepaid debit/stored value account, to make purchases, or exchange for other items of value, based on the terms stated by the issuer.

In one or more embodiments of the method as described with regard to FIG. 11, a smart device 23 in the presence of card or item 30 reads the NFC chip or NFC element that is encoded with a link to a website and is directed to the website. Upon landing at the website, the cardholder is directed to a video to view, or a survey to take, or to another desired task. Upon watching a video, taking a survey, or performing another task specified by the account issuer at the website, the website notifies the card issuer, so they can apply the appropriate credit to the account linked to the card.

Identifying and/or qualifying and/or activating information acquired, read, or otherwise identified from smart device 23 and/or through the activities on the website (or app) can be transferred to a remote host or database, e.g., to secure site or server 22. When being transferred to the remote host or database, e.g., secure site or server 22, for example, the information can be transferred to one or more cell towers/mobile network/wifi provider 42 and then to one or more secure internet storage servers 35, e.g., a Cloud server, and/or then to the remote host or database, e.g., to secure site or server 22.

Information acquired from card or item 30 by smart device 23, including any activating, qualifying or identifying information, can also be transferred to the website or app. The website can further transfer any information acquired on activating, qualifying or triggering events, or information that is reviewed, obtained, analyzed, acquired or identified, to the remote host, e.g., secure site or server 22. When being transferred to remote host 22 from the website, for example, the information can be transferred to one or more cell towers/mobile network/wifi provider 42 and then to one or more secure storage internet servers 35, e.g., a Cloud server, and/or then to the remote host or database, e.g., secure site or server 22.

The credits are applied to the account associated with card or item 30 for use by the cardholder at a secure site.

The cardholder can now use the card or item 30 to make a purchase transaction or exchange for other items of value, e.g., preferably based on the terms stated or as directed by the card issuer.

In various embodiments, the card or item 30 is distributed to a cardholder without requiring a monetary payment from the cardholder.

In various embodiments, the card or item 30 has no monetary value at the time the card 30 is distributed to the cardholder.

In various embodiments, the card or item 30 has little monetary value, e.g., 1 to 10 dollars, at the time the card is distributed to the cardholder.

In various embodiments, the card or item 30 has 1 to 10 dollars, 10-20 dollars, 20 to 30 dollars, 30 to 40 dollars, 40 to 50 dollars, 50 to 100 dollars, 100 to 200 dollars, or any monetary value therebetween.

In various embodiments, the card or item 30 has any desired monetary value at the time the card is distributed to the cardholder.

In general, gift cards are just one type of stored value prepaid debit card; another type is the reloadable open network stored value card now used for promotional, incentive, and loyalty applications. A card or item 30 can be a gift card, a stored value prepaid debit card or a reloadable open network stored value card. Stored value cards used for promotional, incentive, and loyalty applications generally do not leverage chip technology, but can be made to incorporate an embedded NFC chip or other NFC element with NDEF encoding that sends an executable command in the encode string that directs the cardholder's smart device 23, e.g., an NFC enabled smartphone, tablet or similar device to connect to a remotely hosted website and provide secure credentials unique to the specific card or item 30 and thus provide a secure link between the account, e.g., a stored value account of the card or item 30, and subsequent activities of the cardholder while visiting the designated website(s).

Preferably, with the website being access restricted, the website can only be accessed by a cardholder while using the NFC element of the card or item 30, which can be embedded within card or item 30 or affixed to a card or item 30. When in the presence of a smart device 23, e.g., a smartphone, tablet, or other NFC enabled device, the website is designed to verify the NFC element of the card or item 30 and the Primary Account Number (PAN) of the card, tokenized representation of the PAN, or item 30. While visiting the designated website the card issuer may have a task or series of tasks the cardholder can elect to complete that results in the card issuer crediting the account number of card or item 30, e.g., a prepaid account number, with funds through an open or closed network in order to compensate the cardholder for performing the designated activities while visiting the designated website. By adding this technology to a card or item 30, it adds both a marketing function and a compensation function, both in a convenient manner that allows the issuer to credit a consumer's card or item 30 that is already in their possession and does not require mailing or additional distribution costs.

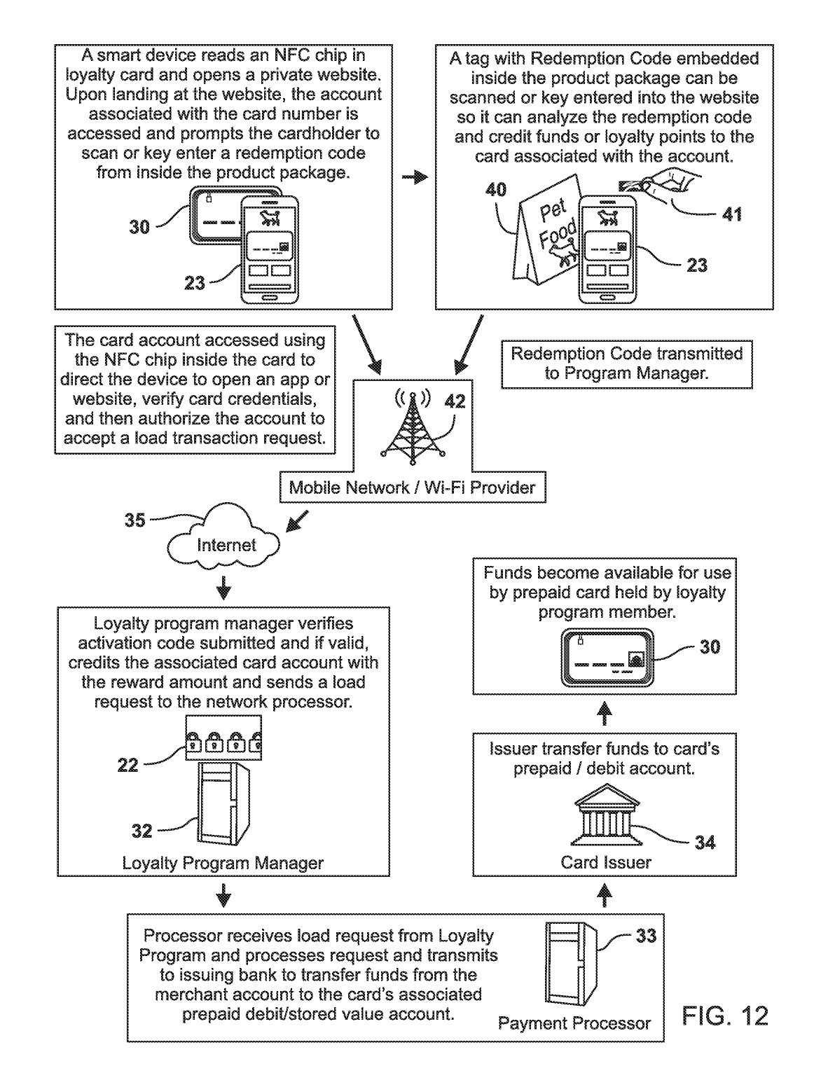

In the embodiment as shown in FIG. 11, a card 30 is illustrated. Card 30 can also be another item such as a letter, greeting card, tag, or other format, e.g., as shown in FIGS. 7A-7G. Card or item 30, e.g., as a letter, greeting card, tag, or other format can, but does not have to, conform to the standard form factor requirements designated by ISO 7810 ID-Type 1, or to other similar standards currently known or to be developed in the future. A card or item 30 in one or more embodiments of the method as shown in FIG. 12 preferably is embedded with premium content and a rebate incentive, that can be associated with purchase. A card or item 30 that can be used in the method of FIG. 11 can have an HF chip 11 and HF antenna 15 as shown in FIGS. 1A-1D or as shown in FIGS. 5A-5D; a UHF chip 21 and UHF antenna 29 as shown in FIGS. 2A-2D; an HF chip 11, HF antenna 15, a UHF chip 21 and UHF antenna 29 as shown in FIGS. 3A-3D; an HF/UHF combination chip 51, HF antenna 15 and UHF antenna 52 as shown in FIGS. 4A-4D; or an HF/UHF combination chip 51, HF/UHF combination antenna 54 as shown in FIGS. 5A-5D. A Quick Response (QR) code including vertical 55 and horizontal 56 barcodes as shown in FIGS. 5A-6D also potentially could be included on a card 30, and which can be read by a QR code scanner or reader. A QR code reader app can also be downloaded to a smart device 21.

Card or item 30, including alternative form factors as shown in FIGS. 7A-7G, and including possibly as a letter, greeting card, tag, or other format can be made of Paper, PVC, PET, styrene, polypropylene, Tyvek®, or other desired material that is about 7 mils to 60 mils thick (175 to 1520 microns). Card or item 30 as a transaction card or prepaid debit card or gift card preferably is made of PVC or PET and is about 7 to 30 mils (175 to 760 microns) thick. If another form for item or card 30 is provided such as a letter, preferably the item is made of paper (natural or synthetic) and is about 5 to 15 mils (125 to 380 microns) thick. If another form for item or card 30 is provided such as a greeting card, preferably the greeting card is made of paper, Tyvek, or OPP (Oriented PolyPropylene) and is about 7 to 24 mils (175 to 610 microns) thick. If another form for item or card 30 is provided such as a label, preferably the label is made of paper, Tyvek, OPP, synthetic paper and is about 7 to 15 mils (175 to 380 microns) thick. If another form for item or card 10 or 30 is provided such as a tag, preferably the tag is made of paper or plastic and is about 10 to 60 mils (250 to 1520 microns) thick.

Card or item 30 as a standard form transaction or payment card or another format such as a letter, greeting card, tag, or other desired format preferably has an embedded or affixed passive High Frequency (HF) RFID chip that supports NFC Data Exchange Format (NDEF) encoding

Card or item 30 as a standard form transaction or payment card, or as another form such as a letter, greeting card, tag, or other desired format preferably has an account associated with an assigned account identifier or account number 16, e.g., a credit, debit, or prepaid debit account number, or tokenized representation thereof, that can be capable of being used for payment of goods or services. The account identifier or account number 16 can be imaged on the surface of the item or card 30, e.g., on front 25 or back 26 of body 18, using inkjet, thermal transfer, laser, or other commercially available variable imaging process, or variable imaging process to be developed in the future. Preferably, the embedded NFC chip or element, e.g., an HF chip 11, is linked to the card's or item's 30 account identifier or account number 16 in a remote host, e.g., a remotely hosted database, with an association being made to a Unique Identification Number (UID) of the card or item 30, or another unique identifying element of the card or item 30 that is encoded into the chip's memory.

Preferably, the embedded NFC chip, e.g., an HF chip 11, is encoded using NFC Data Exchange Format (NDEF), and is encoded to direct a smart device 23, e.g., a smartphone, tablet, or other NFC enabled device to restricted content/premium content, e.g., to a specific website or app that contains content restricted from general audiences and that can be only accessible by said smart device 23, e.g., a smartphone, tablet, or similar NFC enabled device, in the presence of a card or item 30, which can be a standard form transaction or payment card or of another form, such as a letter, greeting card, tag, or other desired format designated by the issuer to have access to the site's content only after validating the card or item 30 has been purchased or otherwise obtained through a qualifying retail transaction or other qualifying transaction.

In some embodiments, access to restricted content can be available when the card or item 30, which can be a standard form transaction or payment card or of another form, such as a letter, greeting card, tag, or other format, is in the presence of a smart device 23.

In other embodiments, access to restricted content can be available when the card 30, which can be a standard form transaction or payment card or of another form, such as a letter, greeting card, tag, or other format is in the presence of a smart device 23 and after a qualifying event, activity or trigger occurs.

In other embodiments, content restricted from general audiences can be accessible by said smart device 23, e.g., a smartphone, tablet, or similar NFC enabled device, after validating or confirming that a qualifying, or activating or triggering event has occurred.

In various embodiments the website or app can verify that the card or item 30 identifier or account number (or tokenized representation thereof) 16 transmitted in the NDEF data stream corresponds with a UID of the chip embedded in or affixed to said card or item 30.

In various embodiments, the website or app can verify a purchase.

Verification of purchase by the website can include an account balance inquiry that can be used to restrict access to content on the basis of account balance, account activity, specific products purchased with said item or card 30, or other account specific criteria established by the issuer.

Verification of purchase by the website can include an account balance inquiry that can be used to restrict access to content on the basis of account balance, account activity, specific products purchased with said item, or other account specific criteria established by the issuer, that is preferably in accordance with terms and conditions of the account as published or otherwise set forth by the issuer at the time the card or item 30, which can be a standard form transaction or payment card or of another form, such as a letter, greeting card, tag, or other format is sold or otherwise conveyed to the initial recipient of the card 30 or another item, letter, greeting card, tag, or other format.

In various embodiments, the website or app can capture the item's 30 identifier or account number, UID, or other uniquely identifiable element, and use at least one of the identifying elements to convey to the issuer that the cardholder has watched a video, completed a survey, or performed a task requested by the issuer as a condition for crediting the card's 30 associated account with funds, purchase credits, purchase units, or other form of stored value. Item 30 can be a standard transaction card or another item such as a letter, greeting card, tag, or other desired format.

Examples of applications of the embodiment of FIG. 11 include the following.

1) An automotive manufacturer passes out prepaid cards, that are of zero value, at a sporting event, but recipients that use their smartphone or tablet to read the card's embedded NFC chip with NDEF encoding are directed to a remotely hosted website where they watch a short video on a new vehicle, then upon completion of the video, the card associated with initiating the viewing session is automatically credited with a value, perhaps $10 or $20. Then, if the card holder subsequently goes to a dealership to test drive the car in the video they can tap their NFC smartphone or tablet to the card that takes them back to the remotely hosted website where they receive an additional $50 load on the card upon entering a code from a dealer and completing a survey on how the car performed in the test drive and on the experience while at the dealership.

2) A marketing firm looking for consumer feedback on a new product distributes open payment network prepaid debit cards with no value to people they see passing through a mall who fit the demographic they want to have review the product for one of their clients. The recipients of the card are able to use their smartphone or tablet to read an embedded NFC chip that directs their device to a private website where, after watching a product demonstration and taking a survey, the prepaid debit account associated with the card they used is credited with a value, perhaps $5 to $100 to compensate them for their time.

3) An appliance manufacturer includes with their registration kit a prepaid card from a detergent manufacturer. The prepaid card is of no value until the recipient uses the embedded NFC element in the card to connect their smartphone or tablet to the detergent manufacturer's website where they are able to scan a bar code or NFC tag on a qualifying package of detergent in order to have the detergent manufacturer's website authorize a credit through an open payment network for a specified amount to the card account associated with the card used to initiate the interaction and thereby reimburse the cardholder for their purchase as an instant rebate (e.g., see also FIG. 12).

4) A cosmetics retailer distributes a loyalty card to their customers that contains an NFC chip that directs a customer's NFC enabled tablet or smartphone to a website where they have access to any number of instructional videos produced by the brands they see in the retailer's store. Upon watching a video the membership card data conveyed by the card's NFC chip is used to credit the cardholder's account with funds or credits that can be used for future purchase transactions by the cardholder with that retailer.

As can be seen, a card of the embodiment of FIG. 11 can be used in countless desired applications, based on different target markets and marketing goals.

In one or more embodiments, a card 10 can be adapted for use in the method of FIG. 11.

FIG. 12 illustrates a third preferred embodiment of the method of the present invention directed to association with purchase/instant rebate. A transaction card as illustrated in FIGS. 9A-9C is shown in the method depicted and described in FIG. 12. A transaction card as illustrated in FIGS. 8A-8C can also be used in one or more embodiments of the method as shown in FIG. 12. A card or item 30 used in the method can be of a standard form transaction or payment card, e.g., as depicted in FIGS. 8A-9C, or of another form, e.g., as depicted in FIGS. 7A-7G, for example. A card or item 30 in one or more embodiments of the method as shown in FIG. 12 preferably is embedded with premium content and a rebate incentive, that can be associated with purchase. A card or item 30 can have an HF chip 11 and HF antenna 15 as shown in FIGS. 1A-1D or as shown in FIGS. 5A-5D; a UHF chip 21 and UHF antenna 29 as shown in FIGS. 2A-2D; an HF chip 11, HF antenna 15, a UHF chip 21 and UHF antenna 29 as shown in FIGS. 3A-3D; an HF/UHF combination chip 51, HF antenna 15 and UHF antenna 52 as shown in FIGS. 4A-4D; an HF/UHF combination chip 51, HF/UHF combination antenna 54 as shown in FIGS. 5A-5D. A Quick Response (QR) code including vertical 55 and horizontal 56 barcodes as shown in FIGS. 5A-6D also potentially could be included on a card 30, and which can be read by a QR code scanner or reader. A QR code reader app can also be downloaded to a smart device 21.

As previously discussed, currently, available mobile phones are designed to read/write/be used with HF/NFC technology. Typically, with the limited space inside mobile phones, the mobile phone manufacturers only put in hardware for NFC/HF communication. Other NFC elements that are currently available or that will be developed in the future can also potentially be included in a card or item 30 and/or a card 10 for use with NFC technology of a mobile phone or other smart device, e.g., NFC technology that is currently available or to be developed in the future for mobile phones and other smart devices. The functionality of said technology shall not be limited to just that of the physical constraints of the device itself, but may be accessible through an extension of the smart device that is created by a separate and distinct unit that connects to the device by cable, Low Energy Blue Tooth (BLE), or other currently available or yet to be developed means of connecting an ancillary unit to a smartphone, tablet, or similar device.

A preferred embodiment of the method as shown in FIG. 12 includes the following steps.

1) A smart device 23 reads an NFC chip in card or item 30, e.g., a loyalty card or branded network payment card, and opens a private website, and wherein upon landing at the website, an account associated with the card account number or identifier 16 is accessed and the cardholder is prompted to scan or key enter a redemption code or key code 41 from a product 40, e.g., obtained from inside the product 40 package.

2) A tag, for example, with a key code or redemption code or activation code 41 embedded inside a product package can be scanned or key entered into the website, using the smart device 23, so the website can analyze the redemption code/key code 41 and credit funds or loyalty points to the card or item 30 associated with the account.

3) The card's or item's 30 account is accessed using the NFC chip or element inside card or item 30 to direct the smart device 23 to open an app or website and verify credentials of the card or item 30 and then authorize the account to accept a load transaction request.

4) The redemption code/key code 41 is transmitted to a program manager, represented by numeral 32 in FIG. 12, e.g., a loyalty program manager.

5) The program manager 32, using a secure site or server 22, verifies that the redemption code /key code 41, which can be an activation code, is submitted and if valid, credits the associated card account with the reward amount and sends a load request to a network or payment processor 33.

6) The network or payment processor 33 receives the load request from the program manager 32 and processes the request and transmits the request to a card issuer 34, e.g., an issuing bank, to transfer funds from the merchant, consumer product company, or other program sponsor's account to the associated account, e.g., a prepaid debit/stored value account or a prepaid/debit account of the card or item 30.

7) The card issuer 34 transfers funds to the associated account, e.g., a prepaid debit/stored value account or a prepaid/debit account of card or item 30.

8) Funds become available for use by the cardholder of card or item 30, which can be a prepaid card, held by the loyalty program member.

In one or more embodiments of the method as shown in FIG. 12, an NFC enabled smart device 23 reads an NFC chip or other NFC element of a card or item 30, e.g., a loyalty card or loyalty item, and opens a private or restricted website. Upon landing at the website, the account associated with the account identifier (or tokenized representation thereof) or number 16 is accessed. The embedded NFC chip is preferably a passive NFC chip. The NFC chip is preferably an NFC chip with NFC Data Exchange Format (NDEF) encoding. The NDEF encode string transmitted to the NFC enabled device, e.g., smart device 23, includes unique identifiers that are specific to the card or item30 being used and allows the activities conducted on the site to be linked to the specific account identifier (or tokenized representation thereof) or account number 16 of card or item 30. The card or item 30 can be a prepaid stored value card. An NFC chip, or other NFC encoded element can be embedded in card or item 30 at the time of manufacture or affixed to an alternative host format at point of distribution, for example.

A redemption code/key code/activation code 41 can be embedded inside a product 40 package or otherwise included with the product 40 package, e.g., on a tag, sticker, label or on the product 40 package itself. The redemption code 41 can be provided to the website, e.g., scanned or key entered into the website, so the redemption code can be analyzed, read or verified, and the website can provide stored value or redeemable value, e.g., credit funds or loyalty points to the card or item 30 associated with the account. With real-time linkage to an existing card or item 30 (which can be a standard form transaction or payment card as shown in FIGS. 8A-9C, or of another form, e.g., as shown in FIGS. 7A-7G) on the site, rebates or purchase incentives can be at the time of purchase, or even prior to purchase. With real-time linkage to an existing card or item 30, rebates or purchase incentives can also be subsequent to purchase, but preferably within a week or less.

Preferably, funds or points become available on a card or item 30 associated with an account that received the funds or purchase credits.

Identifying and/or qualifying and/or activating information acquired, read, identified, or verified from card or item 30 by smart device 23 can be transferred to a remote host or database, e.g., to secure site or server 22. When being transferred to remote host, e.g., secure site or server 22, for example, the information can be transferred to one or more cell towers/mobile network/wifi provider 42 and then to one or more secure storage internet servers 35, e.g., a Cloud server, and/or then to the remote host or database, e.g., secure site or server 22. Information acquired from card or item 30 by smart device 23 along with any activating, qualifying or identifying information can also be transferred to the website or app. The website or app can further transfer any information acquired on activating, qualifying or triggering events, or information that is reviewed, obtained, analyzed, acquired or identified, to the remote host, e.g., secure site or server 22. When being transferred to remote host 22 from the website, for example, the information can be transferred to one or more cell towers/mobile network/wifi provider 42 and then to one or more secure internet storage servers 35 over the internet, e.g., a Cloud server, and/or then to the remote host or database, e.g., secure site or server 22.

In one or more embodiments, a card or item 10 can be used in the embodiment of FIG. 12. A card or item 10/30, which can be a loyalty card is provided by a product or service provider to a customer/account holder.

In one or more embodiments, card or item 10/30, which can be a loyalty card is provided by a local merchant to a customer/account holder.

In one or more embodiments, card or item 10/30, which can be a loyalty card is provided by a sponsor of a promotion.

In one or more embodiments, card or item 10/30, which can be a loyalty card is a stored value card.

In one or more embodiments, card or item 10/30, which can be a loyalty card is an open network prepaid stored value card.

In one or more embodiments, card or item 10/30, which can be a loyalty card is an open network prepaid stored value card.

In one or more embodiments, a manufacturer or brand owner can directly connect with purchasers of its products/services without having to link through a retailer's loyalty program.

In FIG. 12 a card or item 30 is depicted as a standard form transaction card or loyalty card or rewards program card. In other embodiments, card or item 30 can be of another form, e.g., as shown in FIGS. 7A-7G In other embodiments a card or item 30 can be a tag, label, letter, greeting card, or of another form that may or may not conform to standards designated by ISO 7810 ID-Type 1, or to other similar standards currently available or to be developed in the future.

Card or item 30 can be made of paper, PVC, PET, styrene, polypropylene, Tyvek®, or other desired synthetic material, or other desired material, e.g., metal, and can be about 3 mils to 60 mils thick (75 to 1520 microns). Card or item 30 as a standard form transaction card or loyalty card or rewards program card preferably is made of PVC or Paper and is preferably about 15 mils to 30 mils thick (380 to 760 microns). If another form for card or item 30 is provided such as a label, preferably the label is made of paper or OPP and is about 7 to 15 mil (175 to 380 microns) thick. If another form for card or item 30 is provided such as a greeting card, preferably the greeting card is made of paper or synthetic paper and is about 7 to 15 mil (175 to 380 microns) thick. If another form for card or item 30 is provided such as a tag, preferably the tag is made of paper or plastic and is about 12 to 60 mil (300 to 1520 microns) thick. If another form for card or item 30 is provided such as a letter, preferably the letter is made of paper (natural or synthetic) and is about 5 to 15 mils (125 to 380 microns) thick.

Card or item 30, in standard form as shown, for example, in FIGS. 8A-9C or in another form as shown, for example, in FIGS. 7A-7G as a tag, label, letter, greeting card, or other format preferably has a passive High Frequency (HF) RFID chip or element that supports NFC Data Exchange Format (NDEF) encoding, which can be embedded or affixed thereon, for example. Card 30 or the item, tag, label, letter, greeting card, or other desired format is preferably assigned an account identifier or identifying number, e.g., an account number, payment (prepaid debit) account, or loyalty program account. The identifier 16 can allow the card or item's 30 associated identifier or account number 16 to be used for payment for goods or services. The identifier or account number 16, e.g., a payment number, or loyalty number, may or may not be imaged on the surface of the card or item 30 in human readable and/or machine readable form using inkjet, thermal transfer, laser, or other commercially available means of printing variable data, or other process to be developed in the future.

An HF NFC chip, e.g., HF chip 11, preferably has a Unique Identification Number (UID) or other unique identifying element that preferably is encoded into the chip's memory and can be linked in a secure server or site 22, e.g., a database or remote host, to the card's identifier, identifying number, payment number, account number or loyalty number.

Preferably, an embedded HF chip 11, encoded using NFC Data Exchange Format (NDEF), is encoded to direct a smart device 23, e.g., a smartphone, tablet, or other NFC enabled device, to a specific website or app that is only accessible by said smart device 23, e.g., a smartphone, tablet, or similar NFC enabled device in the presence of the card or item 30, in a standard format for a transaction or loyalty card as shown in FIGS. 8A-9C, or in another form such as a tag, label, letter, greeting card, or other desired format, designated by the issuer to have access to the site.

Upon accessing the restricted site using the embedded NFC chip with NDEF encode string, the owner or user of the smart device 23 will be able to associate a qualifying purchase, or other qualifying event, with the account of card or item 30 to receive an instant rebate or purchase credit to be applied to the stored value account associated with said card or item 30, in a standard format for a transaction or loyalty card as shown in FIGS. 8A-9C, or in another form such as a tag, label, letter, greeting card, or other format, and preferably in accordance with the terms of the issuer's program guidelines.

In one or more embodiments, scanning of a product's 40 NFC tag, RFID tag, label, or loyalty reward card, which can be embedded or otherwise included with the product 40, is used to identify the card or item 30 (which can be in a standard format for a transaction or loyalty card as shown in FIGS. 8A-9C, or in another form such as a tag, label, letter, greeting card as shown in FIGS. 7A-7G, or other desired format that qualifies for the rebate or purchase credit).

In some embodiments, the website or app can prompt smart device 23, e.g., a phone or tablet or other NFC enabled device to use a camera to scan a bar code or OCR readable claim code on a product 40, e.g., to receive an instant rebate in the form of a credit to the card or item 30 (which can be in a standard format for a transaction or loyalty card as shown in FIGS. 8A-9C, or in another form such as a tag, label, letter, greeting card as shown in FIGS. 7A-7G, or other desired format that that is associated with the stored value account). Preferably, any such rebate or reward or incentive is in accordance with the terms of the issuer's program guidelines.

In some embodiments, the website or app can require a scan or photo of a purchase receipt, e.g., a scan or photo from a smart device 23, to be submitted and verified by the issuer prior to any reward or incentive credits being applied to the stored value card or item 30 (which can be in a standard format for a transaction or loyalty card as shown in FIGS. 8A-9C, or in another form such as a tag, label, letter, greeting card as shown in FIGS. 7A-7G, or other desired format that is associated with the stored value account).

In some embodiments the website or app requires the cardholder to enter purchase specific data for a product 40 manually.

In some embodiments credit or funds that are applied to the stored value account are made prior to the purchase of a product 40 and based on the smart device's 23 scan, or otherwise recording, of an NFC tag, QR bar code, claim code, or other unique element, embedded within or otherwise included with the product 40, that is used by the product 40 manufacturer, distributor, or retailer to identify the product 40.

In some embodiments, the funds or loyalty credits that can be applied prior to purchase may have an extremely limited expiration period of only a few seconds to a few minutes, e.g., 15 to 45 seconds, or 1 to 5 minutes, and can be restricted for redemption of purchase only of said item or items scanned and associated with the stored value account.

In one or more embodiments, a web browser or app of the smart device 23 can use GPS (Global Positioning System) coordinates of the cardholder's smart device 23 to validate a purchase from an authorized retail location, prior to applying award credits or rebates or other value to an associated account number or identifier 16 of a card or item 30, in a standard format for a transaction or loyalty card as shown in FIGS. 8A-9C, or in another form such as a tag, label, letter, greeting card, or other desired format. An associated account number or identifier 16 can be an associated stored value account identifier or number.

In one or more embodiments, the value, credit or funds applied to the store value account are made only after the card or item 30 has been purchased, and the purchaser performs an action directed by the issuer that prohibits the product from being returned to the merchant for refund.

In one or more embodiments, the value, credit or funds applied to the store value account are made only after the card or item 30 has been purchased.

In one or more embodiments, the value, credit or funds applied to the store value account are made only after the purchaser performs an action directed by the issuer that prohibits the product from being returned to the merchant for refund.

In one or more embodiments, the value, credit or funds applied to the store value account are made after a desired qualifying or activating or triggering event has occurred.

In one or more embodiments, the value, credit or funds applied to the stored value account expire once the GPS location of the consumer's device, e.g., a smart device 23, is outside of the retail location where the purchase incentive is offered. This may be desirable, for example, if a product was not purchased.

In general, stored value debit cards are commonly used for promotional, incentive, and loyalty applications for post-transaction rebates offered by product manufacturers or retailers. These rebate, incentive, or loyalty cards are typically mailed upon receipt of information provided by the consumer proving a qualifying purchase transaction has occurred, and the consumer has satisfied the terms of the promotion that result in the receipt of the card. The downfall of this approach is that the reward is typically received by the consumer several weeks after submitting the documentation and allowing processing time by the program administrator and their mail fulfillment bureau.

In the embodiment as shown in FIG. 12, preferably an NFC chip or other NFC element with NDEF encoding is included with, e.g., embedded inside or affixed to, card or item 30, which preferably is the form of a stored value card, e.g., a prepaid stored value card. When the stored value card 10/30 is in proximity to a cardholder's smart device 23, e.g., an NFC enabled smartphone, tablet, or other similar device 23, (e.g., preferably within 0 to 4 cm distance of the smart device 23), the card or item 10/30 delivers to the smart device 23 an executable code directing the smart device 23 to a designated website or resident app on the smart device 23 that is only accessible to cardholders in the presence of the card or item 10/30. The NDEF encode string transmitted to the smart device 23, e.g., an NFC enabled device, includes unique identifiers that are specific to the card or item 10/30 being used and allows the activities conducted on the website to be linked to the account number or identifier 16 of card or item 30, e.g., to a specific prepaid stored value card's account number. With real-time linkage to an existing card or item 10/30 and to subsequent activity of a card holder, rebates or purchase incentives can be available at the time of purchase, or perhaps even prior to purchase. With the ability to expedite rewarding consumers, the incentive is reinforced and better associated with the purchase transaction so as to improve the consumer experience and further the likelihood of the consumer making additional future qualifying purchase transactions.

Examples of applications of the embodiments of the methods as shown in FIGS. 8 and 9 may include the following.

1) A clothing brand wants to reward its loyal customers regardless of the merchant from whom the consumer purchased the item. Under prior art systems, this is not possible as most loyalty programs are restricted to the Point of Sale (POS) system of the individual merchants selling a product. Under the proposed solution an open network prepaid card (Visa, Mastercard, Discover, AMEX, JCB, Union Pay, etc.) equipped with an NFC chip or other NFC element could be credited with an instant rebate for the purchase of an item. Currently under prior art systems, rebates go through a complex process of submitting receipts to a central clearing agency that then processes the submission and mails a check or debit card to the award recipient. This process can take weeks or months and has the potential for the processing time to be such that the receipt of the reward is not associated with the action that generated the reward. By leveraging an embedded NFC chip with NDEF technology, the sponsor of the promotion has the ability to direct a smartphone, tablet, or other NFC enabled device to a restricted website, log in the card in their possession, verify the card credentials, and then allow a consumer to submit a purchase transaction for a qualified rebate or loyalty credit using the same device's camera or NFC reader to scan a tag, label, or other element embedded within the item purchased that is only generally accessible after the purchase of the item (e.g., hidden under scratch off panel, or a multiple level label where UPC on non-repositionable label stock must be removed to access the claim code). The scan of the item would then be verified by the remote website and then allow a credit to be applied to the open network card's account number allowing it to then be used by the consumer for subsequent purchases with merchants that accept the brand associated with the specific prepaid card.

2) A pet food manufacturer wants to directly connect to the pet owners that purchase their product and bypass the current process of linking through a retailer's loyalty program. With an NFC enabled prepaid card or loyalty card a cardholder can use an NFC enabled smartphone, tablet, or similar device to connect to a remotely hosted website where the embedded data within the chip allows access to the cardholder's account where a subsequent scan of a unique identifying element contained inside the package links purchase activity with the cardholder's account. The unique identifier can, for example, be accessible only with an opened package, which would allow the pet food manufacturer to know the specific product purchased and allow them to credit the cardholder's account with a reward specific to the product purchased. The ability to provide the link through a mobile device and a website allows the product manufacturer to generate dynamic incentives specific to the consumer based on geographic location, product preferences, purchase history, and other factors. For example, this system would allow the pet food manufacturer to provide extra incentives to the consumer when a couple of weeks have passed without a purchase.

As can be seen, a card of the embodiment of FIGS. 8A-9C, which can be of a form of FIGS. 7A-G can be used in countless desired applications based on different target markets and marketing goals.

In the embodiments as shown in the figures, an HF NFC chip is preferably utilized with a card or item in the preferred described embodiments. It should be understood that other NFC elements, that are currently available or that are to be developed in the future, can be utilized in one or more embodiments of the present invention that enable encoding of information/data/content or the like on the element, and wherein the encoded information can be read, transmitted, or otherwise transferred to or shared with a device, e.g., a phone, tablet, smart device or computer.

It should also be understood that other chips or elements currently available or to be developed in the future that enable encoding of desired information/data/content or the like on a chip or element, and wherein the encoded information can be read, scanned, transmitted, or otherwise transferred to and shared with a device, such as a phone, table, smart device or computer, can also be used in one or more or all of the embodiments of the invention as shown and described herein.

An NFC chip that can be used with any of the embodiments as shown and/or described herein preferably has a frequency of about 13.56 mHz and is preferably designed to be read when in close proximity to an NFC enabled device, e.g., when 10 cm or closer to a smart device 23.

A chip or other element that is part of a card or item 10/30, e.g., embedded within or affixed thereto, that can be used with one or more or any of the embodiments as shown and/or described herein preferably has a frequency of about 13.56 mHz and is preferably designed to be read or to have code or content transferred to the smart device 23 when in close proximity to the smart device 23 that is enabled to read or receive code or content from the chip or element, e.g., 10 cm or closer to a smart device 23.

In various embodiments of a card or item 10 or 30 as described herein, it should be understood that barcode portions, QR code portions, identifying numbers, desired text or brand information can be included on a front and/or a back as desired.

### PARTS LIST

10 card/item
11 HF chip
12 magnetic stripe
14 product
15 HF antenna
16 prepaid/debit/account number/account identifier
17 bar code
18 body
19 text/information/disclaimer
20 point of sale terminal
21 UHF chip
22 remote host/database/secure site/secure server/Cloud server
23 NFC enabled smart device/smart phone/tablet
24 premium content/restricted content
25 front/face
26 back
27 value
28 text/information
29 UHF antenna
30 card/item
31 tear line/break line/perforation
32 program manager/program sponsor/contracted host
33 payment processor/network processor
34 card issuer
35 secure internet storage server/cloud server
36 signature panel
37 network branding/security hologram
38 opening
39 expiration date
40 product
41 key code/redemption code/activation code
42 cell tower/mobile network/wifi provider
43 hang tag
44 label
45 front page
46 greeting card
47 back page
48 prepaid card brand format
49 instructions
50 text/message
51 HF/UHF combination chip
52 UHF antenna
53 opening
54 HF/UHF combination antenna
55 vertical barcode
56 horizontal barcode

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the claims.

1. A system for providing access to restricted content, the system comprising:
a) a transaction card having:
i) a card identifier; and
ii) a chip with a chip identifier, the chip encoded with an executable code, and wherein the chip supports near field communication (NFC) Data Exchange Format (NDEF) encoding and is operable to deliver the executable code to an NFC enabled device;
b) a remote host at which the card identifier and chip identifier are linked;
c) wherein the transaction card has an activation function, and wherein when the card is used in an activating event the activating event for the card is recorded at the remote host; and
d) wherein the transaction card has a restricted content access function wherein the restricted content is accessible after the activating event and when the card is in the presence of the NFC enabled device and delivers the executable code to the NFC enabled device that directs the NFC enabled device to the restricted content.

2. The system of claim 1 wherein the NFC enabled device is directed to the restricted content which is on a designated website or software application (“app”) and wherein the restricted content is still restricted after step “d” until a qualifying event is performed at the website or app.

3. The system of claim 2 wherein the qualifying event includes reading content, watching content, or completing a survey.

4. The system of claim 2 wherein the transaction card is a payment card.

5. The system of claim 4 wherein the activating event is purchase of the payment card.

6. The system of claim 4 wherein the payment card includes magnetic stripe data (MSD) or EMV payment chip data.

7. The system of claim 1 wherein the chip identifier and card identifier are passed to the remote host in encrypted or format.

8. The system of claim 1 wherein the chip identifier and card identifier are passed to the remote host in open format.

9. The system of claim 5 wherein the executable code includes an encoded link that serves as a verification element that verifies purchase of the payment card and activates the restricted content on the website or app.

10. The system of claim 1 wherein the remote host is secure.

11. The system in claim 10 wherein the NFC enabled device reads the chip and is directed to a website, and upon landing at the website the card identifier is checked to verify purchase before allowing access to the restricted content.

12. The system in claim 10 wherein after the purchase is verified, the restricted content on the website is released for viewing by the NFC enabled device.

13. The system in claim 1 wherein the NFC enabled device is a smartphone or tablet, and the NFC enabled device reads the chip which directs the NFC enabled device to an internet browser and to a specific website.

14. The system in claim 1 wherein the chip is a passive NFC High Frequency (HF) chip.

15. The system in claim 1 wherein the chip is an Ultra High Frequency (UHF) chip.

16. The system in claim 14 wherein the transaction card contains an HF antenna.

17. The system in claim 15 wherein the transaction card contains a UHF antenna.

18. The system in claim 16 wherein the transaction card contains both the NFC HF chip and a UHF chip and the HF antenna and a UHF antenna.

19. The system in claim 1 wherein the chip is a combination HF frequency and UHF frequency chip and the transaction card contains a combination HF frequency and UHF frequency antenna or both an HF frequency antenna and a UHF frequency antenna.

20. A payment card with embedded restricted content comprising:
a) a card identifier;
b) a chip with a chip identifier, the chip encoded with an executable code, and wherein the chip supports near field communication (NFC) Data Exchange Format (NDEF) encoding and is operable to deliver the executable code to an NFC enabled device;
c) wherein the card identifier and chip identifier are linked in a remote host;
d) the payment card having a payment function, the payment card operable to complete the payment function with either magnetic stripe data or contactless EMV formats;
e) the payment card having an activation function wherein when the card is used in an activating event the activating event for the card is recorded at the remote host; and
f) wherein the payment card has a restricted content access function wherein the restricted content is accessible after the activating event and when the payment card is in the presence of the NFC enabled device and delivers the executable code to the NFC enabled device that directs the NFC enabled device to the restricted content.

21. The payment card of claim 20 wherein the activating event is purchase of the payment card.

22. The payment card of claim 20 wherein the chip identifier and card identifier are passed to the remote host in either encrypted or open format.

23. The payment card of claim 20 wherein the card is made from rigid plastic, PVC, PET, styrene, polypropylene, Tyvek, or other synthetic material, paper, or metal.

24. The payment card of claim 20 wherein the card conforms to ISO 7810 ID-Type 1 form factor.

25. The payment card of claim 20 wherein the chip is a passive High Frequency (HF) NFC chip.

26. The payment card of claim 25 wherein the payment card contains an HF antenna.

27. The payment card of claim 20 wherein the chip is an Ultra High Frequency (UHF) chip.

28. The payment card of claim 27 wherein the payment card contains a UHF antenna.

29. The payment card of claim 20 wherein the chip is a combination HF frequency and UHF frequency chip and the transaction card contains a combination HF and frequency and UHF frequency antenna.

30. The payment card of claim 20 wherein the NFC chip is a combination HF frequency and UHF frequency chip and the transaction card contains an HF frequency antenna and a UHF frequency antenna.

31. The payment card of claim 20 wherein the payment card is a credit card, a debit card, a gift card, or a pre-paid debit card.

32. The payment card of claim 31 wherein the card identifier is an account number that is imaged on a surface of the payment card using inkjet, thermal transfer, laser, or other commercially available variable imaging process.

33. The payment card of claim 31 wherein the payment function of the payment card can be carried out using the card identifier.

34. The payment card of claim 31 wherein the restricted content is restricted to general audiences and only accessible based on the activation function and the restricted content access function of the payment card.

35. The payment card of claim 31 wherein the NFC enabled device is directed to a web page or software application (“app”) on the device to access the restricted content.

36. A method for providing access to restricted media or marketing content, the method including steps of:
a) providing a transaction card having:
i) a card identifier; and
ii) a near field communication (NFC) chip with a chip identifier, the NFC chip encoded with an executable code, and wherein the NFC chip supports near field NFC Data Exchange Format (NDEF) encoding and is operable to deliver the executable code to an NFC enabled device;
b) linking the card identifier and chip identifier at a remote host;
c) activating the transaction card via an activating event and recording the activating event at the remote host; and
d) positioning the card and the NFC enabled device together so that the chip delivers the executable code to the NFC enabled device and directs the NFC enabled device to a designated website or software application (“app”) including the restricted content.

37. The method of claim 36 wherein the NFC enabled device is directed to a designated website or software application (“app”) including the restricted content and restricted content is accessible after accessing the designated website or app.

38. The method of claim 37 wherein the restricted content is still restricted after step “d” until a qualifying event is performed at the website or app.

39. The method of claim 38 wherein the qualifying event includes reading content, watching content, or completing a survey.

40. The method of claim 37 wherein the transaction card that is provided is a payment card.

41. The method of claim 40 wherein the activating event is purchase of the payment card.

42. The method of claim 40 wherein the payment card includes magnetic stripe data (MSD) or EMV payment data.

43. The method of claim 36wherein the chip identifier and card identifier are passed to the remote host in either encrypted or open format.

44. The method of claim 36 wherein the restricted content is accessible after the website verifies the transaction card has been purchased or received a credit through a qualifying retail load transaction.

45. The method of claim 36 wherein the website verifies that the card identifier transmitted in a NDEF data stream corresponds with the chip identifier of the transaction card.

46. The method of claim 41 wherein the payment card has an account associated with the payment card, and the website verifies purchase of the payment card, wherein the verification of purchase by the website includes an account balance inquiry that is used to restrict access to the restricted content on the basis of certain account characteristics, including account balance, account activity, specific products purchased with the transaction card, or other account specific criteria established by a card issuer that are in accordance with terms and conditions of the account as published by the card issuer at the time the transaction card is sold or conveyed to an initial recipient of the payment card.

47. The method of claim 37 where the web site captures the card identifier and uses one or more identifying elements to convey to a card issuer that a cardholder has watched a video, completed a survey, selected crediting the card as an exchange for another award from a loyalty program, or performed a task requested by the card issuer as a condition for crediting the transaction card with stored value, including funds, purchase credits, purchase units, or other form of stored value that can be used for subsequent purchase of goods and services.

48. The method of claim 37 wherein after completing the activating event, a card issuer credits the transaction card with stored value.

49. A system for providing access to restricted content, the system comprising:
a) an item that has:
i) an item identifier; and
ii) an element with an element identifier, the element encoded with an executable code, and wherein the element supports near field communication (NFC) Data Exchange Format (NDEF) encoding and is operable to deliver the executable code to an NFC enabled device;
b) a remote host at which the item identifier and element identifier are linked;
c) the item having an activation function, and wherein when the item is subject to an activating event the activating event for the item is recorded at the remote host; and
d) the item having a restricted content access function wherein the restricted content is accessible after the activating event and when the item is in the presence of the NFC enabled device and delivers the executable code to the NFC enabled device that directs the NFC enabled device to the restricted content.

50. The system of claim 49 wherein the NFC enabled device is directed to a web page or software application (“app”) to access the restricted content.

51. The system of claim 49 wherein element is coupled to the item.

52. The system of claim 49 wherein the element is embedded in the item.

53. The system of claim 49 wherein the item is a transaction card, key fob, hang tag with a transaction card, label, letter, or greeting card.

54. The system of claim 49 wherein the item does not conform to standard form factor requirements designated by ISO 7810 ID-Type 1.

55. The system of claim 49 wherein the item does conform to standard form factor requirements designated by ISO 7810 ID-Type 1.

56. The system of claim 49 wherein the element is a passive NFC High Frequency (HF) RFID chip.

57. The system of claim 56 wherein the item contains an HF antenna.

58. The system of claim 49 wherein the element is an Ultra High Frequency (UHF) chip.

59. The system of claim 58 wherein the item contains a UHF antenna.

60. The system of claim 49 wherein the item contains an HF/UHF combination chip as the element.

61. The system of claim 60 wherein the item contains both an HF antenna and a UHF antenna or wherein the item contains a combination HF/UHF frequency antenna.

62. The system of claim 49 wherein as part of the restricted content access function the item is a key, wherein the restricted content is only accessible by the NFC enabled device in the presence of the item.

63. The system of claim 56 wherein the restricted content is accessible by an item holder after the NFC enabled device is directed to a web page or app at which an item issuer validates that a qualifying event has occurred.

64. The system of claim 63 wherein the qualifying event is purchase of the item.

65. The system of claim 49 wherein the item is made of paper, PVC, PET, styrene, polypropylene, Tyvek®, metal or other material.

66. The system of claim 49 wherein the item is 3 mils to 60 mils thick (75 to 1520 microns).

67. The system of claim 50 wherein the web page or app verifies the item identifier which is transmitted in an NDEF data stream and correlates with the element identifier.

68. The system of claim 67 wherein there is an item account and wherein the verification of the item identifier includes an account balance inquiry that can be used to restrict access to content on the basis of an account balance, account activity, specific products purchased with said item, or other account specific criteria established by an item issuer that are in accordance with terms and conditions of the item account as issued by the issuer at the time the item is obtained by item holder.

69. The item of claim 66 wherein a web page or app captures the item identifier and uses the item identifier as an identifying element to convey to an item issuer that an item holder has watched a video, completed a survey, or performed a task requested by the item issuer as a condition for crediting an item account of the item with an associated payment of funds, purchase credits, purchase units, or other form of stored value.

70. A method for providing access to restricted content, the method including the following steps:
a) providing an item that has:
i) an item identifier; and
ii) a near field communication (NFC) element with an element identifier, the NFC element encoded with an executable code, and wherein the NFC element supports NFC Data Exchange Format (NDEF) encoding and is operable to deliver the executable code to an NFC enabled device; and
iii) wherein the item identifier and element identifier are linked at a remote host;
b) performing an activating event to activate the item; and
c) accessing restricted content after the activating event and when the item is in the presence of the NFC enabled device and delivers the executable code to the NFC enabled device that directs the NFC enabled device to the restricted content.

71. A method for providing access to restricted content, the method includes the following steps:
a) providing an item that has:
i) an item identifier; and
ii) a near field communication (NFC) chip with a chip identifier, the NFC chip encoded with an executable code, and wherein the NFC chip supports NFC Data Exchange Format (NDEF) encoding and is operable to deliver the executable code to an NFC enabled device; and
iii) wherein the item identifier and chip identifier are linked at a remote host;
b) putting the item and NFC enabled device in a desired proximity so that NFC enabled device delivers the executable code to the NFC enabled device and directs the NFC enabled device to an activating event;
c) performing an activating event to activate the item; and
d) accessing restricted content after the activating event.

72. An item for providing access to restricted content, the item comprising:
a) an item identifier;
b) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;
c) wherein the item identifier and chip identifier are linked in a remote host;
d) the item having a payment function;
e) the item having an activation function wherein when the item is subject to an activating event and the activating event for the item is recorded at the remote host; and
f) wherein the item has a restricted content access function wherein the restricted content is accessible when the item is in the presence of the NFC enabled device and delivers the executable code to the NFC enabled device that directs the NFC enabled device to a designated website or software application (“app”) including the restricted content.

73. An item for providing access to restricted content, the item comprising:
a) an item identifier;
b) a near field communication (NFC) chip with a chip identifier, the NFC chip encoded with an executable code, and wherein the NFC chip supports NFC Data Exchange Format (NDEF) encoding and is operable to deliver the executable code to an NFC enabled device;
c) wherein the item identifier and chip identifier are linked in a remote host; and
d) wherein the item has a restricted content access function wherein the restricted content is accessible when the item is in the presence of the NFC enabled device and delivers the executable code to the NFC enabled device that directs the NFC enabled device to the restricted content.

74. A system for providing stored value to an item account based on one or more qualifying actions, the system including:
a) an item that includes:
i) an item identifier, that an item issuer uses to identify the item;
ii) an embedded or affixed passive High Frequency (HF) RFID chip that supports NFC Data Exchange Format (NDEF) encoding;
b) an item account associated with the item identifier;
c) a remote host at which the item identifier and the chip are associated with one another;
d) the item having a restricted access function wherein restricted content is accessible when the chip is read by a device; and
e) a qualifying action requirement, wherein if the qualifying action requirement is satisfied, the stored value is applied to the item account.

75. The system of claim 74 wherein the item identifier is a machine readable element and the restricted content is accessible when the machine readable element is read by a device, website or software application (“app”).

76. The system of claim 75 wherein the machine readable element is selected from the following group:
(a) a near field communication (NFC) element, the NFC element encoded with an executable code, and wherein the NFC chip supports NFC Data Exchange Format (NDEF) encoding and is operable to deliver the executable code to an NFC enabled device;
(b) a QR bar code;
(c) a claim code;
(d) an RFID; or
(e) another desired unique element used by an item manufacturer, distributor, or retailer to identify the item.

77. The system of claim 74, wherein the item is a card, tag, label, letter, greeting card, or other desired format that may or may not conform to standards designated by ISO 7810 ID-Type 1.

78. The system of claim 74 wherein the item is made of paper, PVC, PET, styrene, polypropylene, Tyvek, metal or other desired material.

79. The system of claim 74 wherein the item is 3 mil to 60 mil thick (75 to 1520 microns).

80. The system of claim 76 wherein the machine readable element is an NFC chip and wherein the NFC chip is embedded in the item or affixed to the item.

81. The system of claim 76 wherein the machine readable element is an NFC chip and wherein the NFC chip is a passive High Frequency (HF) RFID chip.

82. The system of claim 76 wherein the machine readable element is an Ultra High Frequency (UHF) chip.

83. The system of claim 81 wherein the item contains an HF antenna.

84. The system of claim 82 wherein the item contains a UHF antenna.

85. The system of claim 76 wherein the item contains more than one machine readable elements.

86. The system of claim 85 wherein the more than one machine readable elements are chips.

87. The system of claim 86 wherein one said chip is a passive High Frequency (HF) chip and another said chip is an Ultra High Frequency (UHF) chip.

88. The system of claim 87 wherein the item contains an HF antenna and a UHF antenna.

89. The system of claim 74 wherein the item is usable for payment of goods or services.

90. The system of claim 74 wherein the item account is a loyalty account and wherein the stored value is reward points.

91. The system of claim 74 wherein the stored value is a rebate or an instant rebate.

92. The system of claim 74 wherein the stored value is a purchase credit.

93. The system of claim 74 wherein the stored value is a monetary value.

94. The system of claim 80 wherein a scan of the item's embedded NFC chip is used to identify the item qualifying for a rebate or purchase credit or loyalty incentive.

95. The system of claim 75 wherein the website or app prompts the NFC enabled device to use a camera to scan the machine readable element of the item in order to receive an instant rebate in the form of a credit to the item account in accordance with terms of an item issuer's program guidelines.

96. The system of claim 58 wherein the website or app requires a scan or photo of a purchase receipt to be submitted and verified by the item issuer prior to issuing the stored value, which is a reward or incentive credits.

97. The system of claim 75 wherein the website or app requires an item holder of the item to enter purchase specific data manually.

98. The system of claim 75 wherein the stored value is a credit of funds or loyalty credits that are applied to the item account prior to a purchase of a good and wherein the credit of funds occurs after a device's scan of a bar code on the good.

99. The system of claim 98 wherein the funds or loyalty credits have a limited expiration period of a few seconds to a few minutes and are restricted for redemption of purchase only of the good scanned and associated with the item account.

100. The system of claim 74 wherein the device has a web browser or a device app that uses GPS coordinates of the device to validate a purchase from an authorized retail location prior to applying the stored value to the item account.

101. The system of claim 74 wherein the stored value is a credit or funds that are applied to the stored value account only after the item has been purchased from a merchant and the purchaser performs an action directed by the issuer that prohibits the item from being returned to the merchant for refund.

102. The system of claim 74 wherein the stored value is a credit or funds that are applied to the stored value account and expire once the GPS location of the consumer's device is outside of a retail location where the stored value is offered.

103. A stored value item comprises:
a) an item identifier;
b) a near field communication (NFC) element, the NFC element encoded with an executable code, and wherein the NFC element supports NFC Data Exchange Format (NDEF) encoding and is operable to deliver the executable code to an NFC enabled device;
c) an item account associated with the item identifier;
d) a restricted access function wherein restricted access to a website or software application (“app”) is accessible when the item identifier is read by a device; and
e) a qualifying action requirement, wherein if the qualifying action requirement is satisfied, a stored value is applied to the item account.

104. The item of claim 103 wherein the item identifier is a machine readable element that is selected from the following group:
(a) a near field communication (NFC) element, the NFC element encoded with an executable code, and wherein the NFC element supports NFC Data Exchange Format (NDEF) encoding and is operable to deliver the executable code to an NFC enabled device;
(b) a QR bar code;
(c) a claim code;
(d) an RFID; or
(e) another desired machine readable element used by an item manufacturer, distributor, or retailer to identify the item.

105. The item of claim 103, wherein the item is a card, tag, label, letter, greeting card, or of another desired format that may or may not conform to standards designated by ISO 7810 ID-Type 1.

106. The item of claim 103 wherein the item is made of paper, PVC, PET, styrene, polypropylene, Tyvek, metal or other material.

107. The item of claim 103 wherein the item is 3 mil to 60 mil thick (75 to 1520 microns).

108. The item of claim 104 wherein the NFC element is an NFC chip which is embedded in the item or affixed to the item.

109. The item of claim 104 wherein the NFC chip is a passive High Frequency (HF) RFID chip.

110. The item of claim 104 wherein the desired machine readable element is an Ultra High Frequency (UHF) chip.

111. The item of claim 109 wherein the item contains an HF antenna.

112. The item of claim 110 wherein the item contains an UHF antenna.

113. The item of claim 104 wherein the item contains more than one machine readable element.

114. The item of claim 113 wherein one machine readable element is a passive High Frequency (HF) chip and another machine readable element is an Ultra High Frequency (UHF) chip.

115. The system of claim 113 wherein the item contains an HF antenna and an UHF antenna.

116. The item of claim 103 wherein the item is usable for payment of goods or services.

117. The item of claim 103 wherein the item account is a loyalty account and wherein the stored value is reward points.

118. The item of claim 103 wherein the stored value is a rebate or an instant rebate.

119. The item of claim 103 wherein the stored value is a purchase credit.

120. The item of claim 103 wherein the stored value is a monetary value.

121. The item of claim 108 wherein a scan of the item's embedded NFC chip is used to identify the item qualifying for a rebate or purchase credit or loyalty incentive.

122. An item that can be used to access restricted content and/or to obtain stored value, the item comprising:
a) an item identifier;
b) an electronic element affixed to the item or embedded in the item, the electronic element having information encoded thereon that can be read by, transferred to, or shared with an electronic device;
c) an item account associated with the item identifier;
d) an element identifier; and
e) a qualifying action requirement, wherein if the qualifying action requirement is satisfied, access to restricted content is obtained or the stored value is applied to the item account in real time or at least nearly instantaneously.

123. The item of claim 122 wherein the electronic element is an NFC chip.

124. The item of claim 122 wherein the electronic element is a UHF chip.

125. The item of claim 122 wherein the electronic element is a machine readable element.

126. A method for providing stored value to an item account based on one or more qualifying actions, the method comprising steps of:
a) providing an item that includes:
i) an item identifier that an item issuer uses to identify the item; and
ii) an electronic element affixed to the item or embedded in the item, the electronic element having information encoded thereon that can be read by, transferred to, or shared with an electronic device, the electronic element having an element identifier;
b) providing an item account associated with the item identifier;
c) linking the item identifier, electronic element, and item account at a remote host;
d) unlocking restricted information on a qualifying action by placing the item in proximity of an NFC enabled device and having the device read the machine readable element; and
e) performing a qualifying action so that a stored value can be applied to the item account.

127. The method of claim 126 wherein the item identifier is a machine readable element and wherein in step (d) after the device reads the machine readable element access to a website or software application is unlocked.

128. The method of claim 127 wherein the machine readable element of the item provided is a near field communication (NFC) chip, the NFC chip is encoded with an executable code, and wherein the NFC chip supports NFC Data Exchange Format (NDEF) encoding and is operable to deliver the executable code to a NFC enabled device; or a QR bar code; or a claim code;
or an RFID; or a UHF chip, or another unique element used by a product manufacturer, distributor, or retailer to identify a product.

129. The method of claim 126, wherein the item provided in step (a) is a card, tag, label, letter, greeting card, or other format that may or may not conform to standards designated by ISO 7810 ID-Type 1.

130. The method of claim 126 further comprising a step of using the item for payment of goods or services.

131. The method of claim 126 wherein the item account that is provided is a loyalty account and wherein the stored value is reward points.

132. The method of claim 126 wherein the stored value applied to the item is a rebate or an instant rebate.

133. The method of claim 126 wherein the stored value applied to the item is a purchase credit.

134. The method of claim 126 wherein the stored value applied to the item is a monetary value.

135. The method of claim 127 further comprising scanning the item's machine readable element to identify whether the item account qualifies for a rebate or purchase credit or loyalty incentive.

136. The method of claim 127 further comprising wherein the website or app prompts the NFC enabled device to use a camera to scan the machine readable element of the item in order to receive an instant rebate in the form of a credit to the item.

137. The method of claim 127 further comprising wherein the website or app prompts the NFC enabled device to use a camera to scan the machine readable element of the item in order to receive an instant rebate in the form of a credit to the item account in accordance with terms of an item issuer's program guidelines.

138. The method of claim 127 further comprising wherein the website or app requires a scan or photo of a purchase receipt to be submitted and verified by the item issuer prior to issuing the stored value.

139. The method of claim 138 wherein the stored value issued is a reward or incentive credits.

140. The method if claim 127 further comprising wherein the website or app requires an item holder of the item to enter purchase specific data manually.

141. The method if claim 140 wherein the stored value that is issued is a credit of funds or loyalty credits that are applied to the item account prior to a purchase of a good and wherein the credit of funds occurs after a device's scan of a bar code on the good.

142. The method of claim 141 wherein the funds or loyalty credits have a limited expiration period of a few seconds to a few minutes and are restricted for redemption of purchase only of the good scanned and associated with the item account.

143. A system for issuing a rebate or purchase credit or other stored value, the system comprising:
a) an item having an embedded or affixed passive High Frequency (HF) chip that supports NFC Data Exchange Format (NDEF) encoding;
b) the chip encoded with content;
c) an item identifier associated with an item account;
d) a chip identifier; and
e) a stored value function wherein stored value is applied to the item account after verifying that one or more requirements are met.

144. The system of claim 143 wherein one of said requirements is that the item be in the presence of a device that can receive encoded information from the item.

145. The system of claim 143 wherein one of said requirements is that a qualifying purchase was made.

146. The system of claim 144 wherein another of said requirements is that a qualifying purchase was made.

147. The system of claim 144 wherein an Ultra High Frequency (UHF) chip is utilized in place of the HF chip.

148. The system of claim 49 wherein the item is provided to a recipient without purchase or without the recipient requesting the item.

149. The system of claim 79 wherein the item is provided to a recipient without purchase or without the recipient requesting the item.

150. The system of claim 107 wherein the item is provided to a recipient without purchase or without the recipient requesting the item.

151. (canceled)
